(19) United States
(12) Patent Application Publication
(10) Pub. No.: US 2022/0337355 A1
(43) Pub. Date: Oct. 20, 2022

(54) Acknowledgement Feedback for Sidelink Communications

(71) Applicant: Telefonaktiebolaget LM Ericsson (publ), Stockholm (SE)

(72) Inventors: Hieu Do, Järfälla (SE); Ricardo Blasco Serrano, Espoo (FI); Wanlu Sun, San Diego, CA (US); Shehzad Ali Ashraf, Aachen (DE); Jose Angel Leon Calvo, Aachen (DE)

(21) Appl. No.: 17/635,145

(22) PCT Filed: Aug. 14, 2020
(86) PCT No.: PCT/EP2020/072857

§ 371 Date: Feb. 14, 2022

Related U.S. Application Data
(60) Provisional application No. 62/887,284, filed on Aug. 15, 2019.

(51) Int. Cl. H04L 1/18; H04L 5/00; H04W 72/04

(52) U.S. Cl. CPC H04L 1/1854; H04L 1/1861; H04L 5/0055; H04W 72/0406; H04W 4/40

(57) ABSTRACT

A wireless device (12A) receives a data transmission (22) from a peer wireless device (12B) on a sidelink (20) between the wireless device (12A) and the peer wireless device (12B). The wireless device (12A) transmits, to the peer wireless device (12B), a sequence (26) that is based on an identity (32B) of the peer wireless device (12B). Transmission of the sequence (26) conveys acknowledgement feedback (24) for the data transmission (22).

### TECHNICAL FIELD

The present application relates generally to sidelink communications between wireless devices, and relates more particularly to acknowledgement feedback for such sidelink communications.

### BACKGROUND

A wireless device that receives a downlink data transmission from a wireless communication network transmits acknowledgement feedback to the network in order to indicate whether the transmission was received with or without error, e.g., at the physical layer. This way, if the wireless device received the downlink data transmission with error, the network can retransmit it so as to realize reliable communication with the wireless device.

The network schedules different wireless devices to transmit acknowledgement feedback to the network on orthogonal radio resources. The network transmits scheduling information to the wireless devices to indicate this scheduling. By coordinating radio resource usage in this way, the network ensures it can distinguish the acknowledgement feedback of one device from the acknowledgement feedback of other devices.

These and other aspects of acknowledgement feedback, however, prove challenging for direct communication between wireless devices over a sidelink. This is due at least in part to the distributed nature of the sidelink limiting the ability of the network to coordinate resource selection and other parameters for acknowledgment feedback.

### SUMMARY

Some embodiments herein facilitate acknowledgement feedback for sidelink communication between wireless devices. Some embodiments for instance convey such acknowledgement feedback by transmitting a sequence. In one or more embodiments, the sequence is based on an identity of the wireless device to which the acknowledgement feedback is conveyed, an identity of the wireless device conveying the acknowledgement feedback, and/or a distance between those wireless devices. Alternatively or additionally, some embodiments transmit the sequence on a resource block that is based on an identity of the wireless device transmitting the acknowledgement feedback and/or based on the acknowledgement feedback itself. Still other embodiments herein alternatively or additionally govern on which subchannel the sequence is transmitted. Other embodiments herein alternatively or additionally schedule when acknowledgment feedback is to be transmitted based on when other acknowledgment feedback is to be transmitted or received. These and other embodiments may thereby facilitate acknowledgement feedback for sidelink communications despite the distributed nature of the sidelink and/or without meaningful impact on signalling overhead.

More particularly, embodiments herein include a method performed by a wireless device. The method comprises receiving a data transmission from a peer wireless device on a sidelink between the wireless device and the peer wireless device. The method further comprises transmitting, to the peer wireless device, a sequence that is based on an identity of the peer wireless device. In some embodiments, transmission of the sequence conveys acknowledgement feedback for the data transmission.

In some embodiments, the method further comprises generating or selecting the sequence based on the identity of the peer wireless device.

In some embodiments, the sequence is also based on an identity of the wireless device.

In some embodiments, the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

In some embodiments, the method further comprises selecting a resource block in which to transmit the sequence, wherein selecting the resource block is based on an identity of the wireless device, and wherein transmitting the sequence comprises transmitting the sequence in the selected resource block.

In some embodiments, the method further comprises selecting a resource block in which to transmit the sequence on a certain subchannel, wherein selecting the resource block comprises selecting the resource block among multiple resource blocks in the certain subchannel, and wherein transmitting the sequence comprises transmitting the sequence in the selected resource block.

In some embodiments, transmitting the sequence comprises transmitting the sequence on the same subchannel as the subchannel on which the data transmission is received.

In some embodiments, the data transmission is a vehicle-to-everything, V2X, data transmission on a sidelink between the wireless device and the peer wireless device.

In some embodiments, the sequence is transmitted on a physical sidelink feedback channel, PSFCH.

Embodiments herein also include a method performed by a wireless device. The method comprises receiving a data transmission from a peer wireless device on a sidelink between the wireless device and the peer wireless device. The method also comprises selecting a resource block in which to transmit a sequence for conveying acknowledgement feedback for the data transmission. The resource block is selected based on an identity of the wireless device. The method also comprises transmitting the sequence to the peer wireless device on the selected resource block.

In some embodiments, selecting the resource block comprises selecting the resource block among multiple resource blocks across multiple subchannels, wherein each subchannel includes one or more resource blocks.

In some embodiments, the sequence is transmitted on a certain subchannel, and wherein selecting the resource block comprises selecting the resource block among multiple resource blocks in the certain subchannel.

In some embodiments, transmitting the sequence comprises transmitting the sequence on the same subchannel as the subchannel on which the data transmission is received.

In some embodiments, the data transmission is a vehicle-to-everything, V2X, data transmission on a sidelink between the wireless device and the peer wireless device.

In some embodiments, the sequence is transmitted on a physical sidelink feedback channel, PSFCH.

Embodiments herein further include a method performed by a wireless device. The method comprises receiving a data transmission from a peer wireless device on a subchannel of a sidelink between the wireless device and the peer wireless device. The method also comprises transmitting a sequence to the peer wireless device on the same subchannel as the subchannel on which the data transmission was received, wherein transmission of the sequence conveys acknowledgement feedback for the data transmission.

Embodiments herein also include a method performed by a wireless device. The method comprises determining, from among multiple acknowledgement feedback operations to be performed in the same time slot, a subset of the multiple acknowledgement feedback operations to perform in the time slot, based on one or more rules that assign respective priorities to the multiple acknowledgment feedback operations. The method also comprises performing, in the time slot, the acknowledgment feedback operations included in the determined subset.

In some embodiments, the multiple acknowledgement feedback operations include transmitting positive acknowledgment of a first data transmission and transmitting negative acknowledgement of a second data transmission.

In some embodiments, the first data transmission is a groupcast transmission, and wherein the determined subset includes transmitting the negative acknowledgment and excludes transmitting the positive acknowledgement.

In some embodiments, the one or more rules assign respective priorities to the multiple acknowledgment feedback operations based on one or more of: whether an acknowledgement feedback operation is for transmitting or receiving acknowledgement feedback; whether acknowledgement feedback for an acknowledgment feedback operation is a positive acknowledgement or a negative acknowledgement; or whether a data transmission for which an acknowledgment feedback operation is to be performed is a unicast transmission or a groupcast transmission.

Embodiments further include a method performed by a peer wireless device. The method comprises transmitting a data transmission from the peer wireless device to a wireless device on a sidelink between the wireless device and the peer wireless device. The method also comprises receiving, from the wireless device, a transmission of a sequence that is based on an identity of the peer wireless device, wherein the transmission of the sequence conveys acknowledgement feedback for the data transmission.

In some embodiments, the sequence is also based on an identity of the wireless device.

In some embodiments, the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

In some embodiments, the sequence is received on a resource block associated with an identity of the wireless device.

In some embodiments, receiving the sequence comprises receiving the sequence on the same subchannel as the subchannel on which the data transmission is transmitted.

In some embodiments, the data transmission is a vehicle-to-everything, V2X, data transmission on a sidelink between the wireless device and the peer wireless device.

In some embodiments, the sequence is received on a physical sidelink feedback channel, PSFCH.

Embodiments herein further include a method performed by a peer wireless device. The method comprises transmitting a data transmission from the peer wireless device to a wireless device on a sidelink between the wireless device and the peer wireless device. The method also comprises receiving a transmission of a sequence from the wireless device, wherein the transmission of the sequence conveys acknowledgment feedback for the data transmission, wherein the transmission of the sequence is received on a resource block that depends on an identity of the wireless device.

In some embodiments, receiving the sequence comprises receiving the sequence on the same subchannel as the subchannel on which the data transmission is transmitted.

In some embodiments, the data transmission is a vehicle-to-everything, V2X, data transmission on a sidelink between the wireless device and the peer wireless device.

In some embodiments, the sequence is received on a physical sidelink feedback channel, PSFCH.

Embodiments herein also include a method performed by a peer wireless device. The method comprises transmitting a data transmission from the peer wireless device to a wireless device on a subchannel of a sidelink between the wireless device and the peer wireless device. The method further comprises receiving a transmission of a sequence from the wireless device on the same subchannel as the subchannel on which the data transmission was transmitted, wherein the transmission of the sequence conveys acknowledgement feedback for the data transmission.

In some embodiments, the data transmission is a vehicle-to-everything, V2X, data transmission on a sidelink between the wireless device and the peer wireless device.

In some embodiments, the sequence is received on a physical sidelink feedback channel, PSFCH.

Embodiments also include corresponding apparatus, computer programs, and carriers of those computer programs. For example, embodiments herein include a wireless device, e.g., comprising communication circuitry and processing circuitry. The wireless device is configured to receive a data transmission from a peer wireless device on a sidelink between the wireless device and the peer wireless device. The wireless device is also configured to transmit, to the peer wireless device, a sequence that is based on an identity of the peer wireless device, wherein transmission of the sequence conveys acknowledgement feedback for the data transmission.

Embodiments also herein include a wireless device, e.g., comprising communication circuitry and processing circuitry. The wireless device is configured to receive a data transmission from a peer wireless device on a sidelink between the wireless device and the peer wireless device. The wireless device is further configured to select a resource block in which to transmit a sequence for conveying acknowledgement feedback for the data transmission, wherein the resource block is selected based on an identity of the wireless device. The wireless device is also configured to transmit the sequence to the peer wireless device on the selected resource block.

Embodiments herein include a wireless device, e.g., comprising communication circuitry and processing circuitry. The wireless device is configured to receive a data transmission from a peer wireless device on a subchannel of a sidelink between the wireless device and the peer wireless device. The wireless device is further configured to transmit a sequence to the peer wireless device on the same subchannel as the subchannel on which the data transmission was received, wherein transmission of the sequence conveys acknowledgement feedback for the data transmission.

Embodiments herein include a wireless device, e.g., comprising communication circuitry and processing circuitry. The wireless device is configured to determine, from among multiple acknowledgement feedback operations to be performed in the same time slot, a subset of the multiple acknowledgement feedback operations to perform in the time slot, based on one or more rules that assign respective priorities to the multiple acknowledgment feedback operation. The wireless device is further configured to perform, in the time slot, the acknowledgment feedback operations included in the determined subset.

Embodiments herein include a peer wireless device, e.g., comprising communication circuitry and processing circuitry. The peer wireless device is configured to transmit a data transmission from the peer wireless device to a wireless device on a sidelink between the wireless device and the peer wireless device. The peer wireless device is further configured to receive, from the wireless device, a transmission of a sequence that is based on an identity of the peer wireless device, wherein the transmission of the sequence conveys acknowledgement feedback for the data transmission.

Embodiments herein also include a peer wireless device, e.g., comprising communication circuitry and processing circuitry. The peer wireless device is configured to transmit a data transmission from the peer wireless device to a wireless device on a sidelink between the wireless device and the peer wireless device. The peer wireless device is also configured to receive a transmission of a sequence from the wireless device, wherein the transmission of the sequence conveys acknowledgment feedback for the data transmission, wherein the transmission of the sequence is received on a resource block that depends on an identity of the wireless device.

Embodiments herein include a peer wireless device, e.g., comprising communication circuitry and processing circuitry. The peer wireless device is configured to transmit a data transmission from the peer wireless device to a wireless device on a subchannel of a sidelink between the wireless device and the peer wireless device. The peer wireless device is also configured to receive a transmission of a sequence from the wireless device on the same subchannel as the subchannel on which the data transmission was transmitted, wherein the transmission of the sequence conveys acknowledgement feedback for the data transmission.

### BRIEF DESCRIPTION OF THE DRAWINGS

FIG. 1 is a block diagram of a wireless communication system according to some embodiments.

FIG. 2 is a block diagram of resource block selection according to some embodiments.

FIG. 3 is a block diagram of resource block selection according to other embodiments.

FIG. 4 is a block diagram of sequence generation based on ranges of distances according to some embodiments.

FIG. 5 is a block diagram of sequence transmission based on a subchannel according to some embodiments.

FIG. 6 is a logic flow diagram of a method performed by a wireless device according to some embodiments.

FIG. 7 is a logic flow diagram of a method performed by a peer wireless device according to some embodiments.

FIG. 8 is a logic flow diagram of a method performed by a radio network node according to some embodiments.

FIG. 9 is a logic flow diagram of a method performed by a wireless device according to other embodiments.

FIG. 10 is a logic flow diagram of a method performed by a wireless device according to still other embodiments.

FIG. 11 is a logic flow diagram of a method performed by a wireless device according to yet other embodiments.

FIG. 12 is a block diagram of a wireless device according to some embodiments.

FIG. 13 is a block diagram of a network node according to some embodiments.

FIG. 14 is a block diagram of a vehicle-to-anything (V2X) communications system according to some embodiments.

FIG. 15 is a block diagram of a Physical Uplink Control Channel (PUCCH) format 0 according to some embodiments.

FIG. 16 is a block diagram of subchannels in a sidelink resource pool according to some embodiments.

FIG. 17 is a block diagram of PSFCH transmission/reception according to some embodiments.

FIG. 18 is a block diagram of PSFCH sequence generation according to some embodiments.

FIG. 19 is a block diagram of resource selection according to some embodiments.

FIG. 20 is a block diagram of resource selection according to other embodiments.

FIG. 21 is a block diagram of a wireless communication network according to some embodiments.

FIG. 22 is a block diagram of a user equipment according to some embodiments.

FIG. 23 is a block diagram of a virtualization environment according to some embodiments.

FIG. 24 is a block diagram of a communication network with a host computer according to some embodiments.

FIG. 25 is a block diagram of a host computer according to some embodiments.

FIG. 26 is a flowchart illustrating a method implemented in a communication system, in accordance with one embodiment.

FIG. 27 is a flowchart illustrating a method implemented in a communication system, in accordance with one embodiment.

FIG. 28 is a flowchart illustrating a method implemented in a communication system, in accordance with one embodiment.

FIG. 29 is a flowchart illustrating a method implemented in a communication system, in accordance with one embodiment.

### DETAILED DESCRIPTION

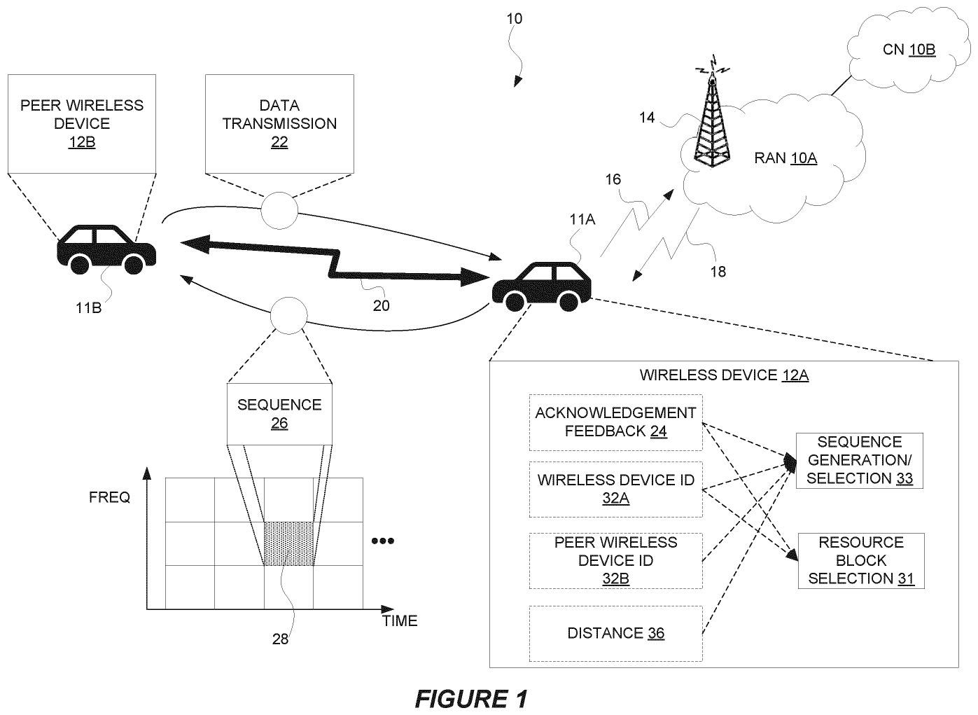

FIG. 1 shows a wireless communication system 10 according to some embodiments. The system 10 includes a radio access network (RAN) 10A and a core network (CN) 10B. The RAN 10A provides radio access to one or more wireless devices (e.g., user equipment, UE) and connects the wireless device(s) to the CN 10B. The CN 10B in turn connects the wireless device(s) to one or more data networks, e.g., the Internet.

FIG. 1 in particular shows a wireless device 12A. The wireless device 12A may be configured to wirelessly communicate with a radio network node 14 in the RAN 10A. The wireless device 12 in this regard may transmit communications to the radio network node 14 over an uplink 16 and may receive communications from the radio network node 14 over a downlink 18. Notably, the wireless device 12 is alternatively or additionally configured to directly communicate with a peer wireless device 12B over a sidelink 20. The wireless device 12A in this regard may have a direct connection with the peer wireless device 12B over the sidelink 20, without any intervening network nodes. In some embodiments, one or both of the wireless devices 12A, 12B are machine-type communication (MTC) devices or vehicle-to-everything (V2X) devices. Indeed, as shown in FIG. 1, wireless device 12A is embedded, integrated, positioned within, or otherwise associated with a vehicle 11A, and peer wireless device 12B is embedded, integrated, positioned within, or otherwise associated with a vehicle 11B.

As shown in FIG. 1, the wireless device 12A receives a data transmission 22 (e.g., a data packet or transport block) from the peer wireless device 12B on the sidelink 20, e.g., over a data channel such as a physical sidelink shared channel (PSSCH). The data transmission 22 may for instance be a V2X transmission. Regardless, the wireless device 12A may attempt to decode the received data transmission 22, e.g., by checking the received data transmission 22 for errors and, in some embodiments, correcting any detected errors that are correctable. The wireless device 12A may then convey acknowledgement feedback 24 back to the peer wireless device 12B, in order to positively acknowledge the data transmission 22 as being successfully decoded without error (ACK) or negatively acknowledge the data transmission 22 as being unsuccessfully decoded (NACK). The acknowledgement feedback 24 may for instance be hybrid automatic repeat request (HARQ) feedback. The wireless device 12A may convey the acknowledgment feedback 24 on a sidelink control channel, e.g., a physical sidelink feedback channel (PSFCH) or a physical sidelink control channel (PSCCH). In some embodiments, the wireless device 12A conveys this acknowledgement feedback 24 by transmitting a sequence 26 (e.g., a Zadoff-Chu sequence) to the peer wireless device 12B. That is, it is the transmission of the sequence 26 that conveys the acknowledgment feedback 24.

In some embodiments, for example, it is the transmission of the sequence 26 on a certain resource block 28, not the sequence 26 content itself, that conveys the acknowledgement feedback 24. Here, a resource block 28 may for instance be a block of time-frequency resources, e.g., a block of resource elements. In other words, the resource block 28 on which the sequence 26 is transmitted implicitly conveys the acknowledgment feedback 24. In some of these embodiments, then, the wireless device 12A selects the resource block 28 on which to transmit the sequence 26, based on the acknowledgment feedback 24 to be conveyed. FIG. 1 in this regard shows that resource block selection 31 at the wireless device 12A may take as input the acknowledgment feedback 24 to be conveyed.

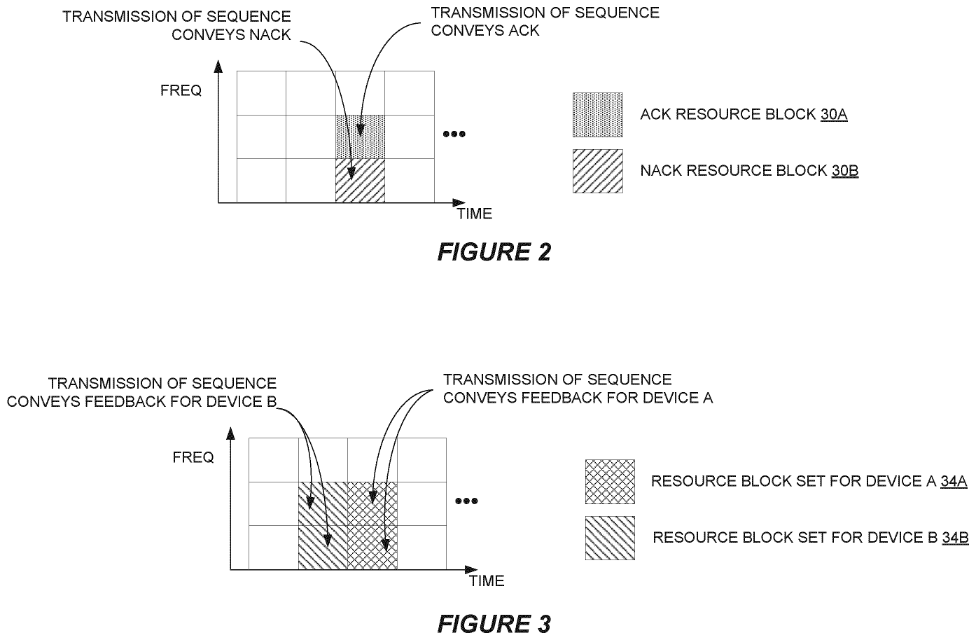

As shown in FIG. 2, for example, different candidate resource blocks 30A, 30B may be respectively associated with positive acknowledgement (ACK) and negative acknowledgement (NACK). The transmission of the sequence 26 on the resource block 30A associated with positive acknowledgement conveys positive acknowledgment of the data transmission 22, whereas transmission of the same sequence 26 on the resource block 30B associated with negative acknowledgement conveys negative acknowledgement of the data transmission 22. In some embodiments, for example, the resource block with the lower index is for positive acknowledgement, whereas the resource block with the higher index is for negative acknowledgement. Separating positive acknowledgement and negative acknowledgement into different resource blocks may advantageously allow for clear differentiation of positive and negative acknowledgement at the peer wireless device 12B.

Although illustrated in FIG. 1 with respect to resource block selection, the acknowledgment feedback 24 may be implicitly conveyed in other embodiments via selection of any other type of radio resource (e.g., in time, frequency, and/or code) on which to transmit the sequence 26.

Alternatively or additionally to implicitly conveying the acknowledgement feedback 24 via such selection, some embodiments herein concern how to indicate that the acknowledgement feedback 24 is from the wireless device 12A and/or how to at least differentiate the acknowledgment feedback 24 from the wireless device 12A from the acknowledgement feedback from another wireless device (not shown). One or more embodiments, for example, similarly exploit resource block selection for this purpose. In these embodiments, the wireless device 10A selects the resource block 28 on which to transmit the sequence 26, based on an identity 32A of the wireless device 12A, e.g., a physical layer (i.e., Layer 1) identity. FIG. 1 for instance shows that resource block selection 31 at the wireless device 12A may alternatively or additionally take as input such identity 32A. In such an embodiment, then, the wireless device 12A in FIG. 1 may select the resource block 28 on which to transmit the sequence 26 as being a resource block that is associated with the wireless device's identity 32A, e.g., as being a resource block included in a set of resource block(s) associated with the wireless device's identity 32A.

As shown in FIG. 3, for example, different sets 34A, 34B of one or more resource blocks may be respectively associated with different wireless devices A, B. Transmission of a sequence on any resource block in set 34A may convey acknowledgement feedback for device A, whereas transmission of a sequence (even the same sequence) may convey acknowledgement feedback for device B.

Using different resource block sets for different wireless devices may advantageously allow for randomization of the interference caused by each device's acknowledgment feedback, e.g., avoiding the scenario where the same resource block is selected by multiple devices for acknowledgment feedback. In some embodiments, the peer wireless device 12B may have knowledge of which resource block sets are associated with which wireless devices, in which case the peer wireless device 12B may identify certain acknowledgement feedback as being conveyed from certain wireless devices. In other embodiments, by contrast, such as where the peer wireless device 12B need not know which resource blocks are associated with which wireless devices, the peer wireless device 12B may nonetheless differentiate acknowledgement feedback conveyed on different resource block sets as being conveyed from different wireless devices (without necessarily understanding which particular wireless device conveyed which acknowledgement feedback). This latter case may for instance prove useful where the data transmission 22 is a groupcast or broadcast transmission. Indeed, with a groupcast or broadcast transmission, the peer wireless device 12B simply needs to know whether any wireless device (as opposed to which wireless device) negatively acknowledges the data transmission 22. If any wireless device negatively acknowledges the data transmission 22 in this case, the peer wireless device 12B retransmits the data transmission 22, no matter which wireless device negatively acknowledges the data transmission 22.

In one example, the resource pool or the subchannel of interest consists of 2*K resource blocks, e.g., assuming an even number of resource blocks (RBs). This will be divided into K disjoint consecutive RB pairs (each pair consists of 2 consecutive RBs), indexed from 1 to K. A wireless device with ID=N will select the RB pair with index=N modulo K.

In any event, combined with embodiments above, the resource block selection in some embodiments may be based on both the wireless device's identity 32A and the acknowledgement feedback 24. For example, the wireless device 12A may first select a set of resource blocks associated with the wireless device's identity 32A and then select the resource block 28 on which to transmit the sequence 26 from among the resource blocks included in the selected set.

In some embodiments, multiple different subchannels (not shown) are defined in the frequency domain, with each subchannel comprising one or more resource blocks. In this case, in some embodiments, the resource block selection described above may occur across subchannels, such that the wireless device 12A selects the resource block 28 on which to transmit the sequence from among multiple resource blocks across multiple subchannels. The resource block selection in this case dictates, controls, or otherwise impacts subchannel selection. In other embodiments, by contrast, the resource block selection may occur within a certain subchannel (e.g., where the certain subchannel is otherwise selected or determined). In this case, the wireless device 12A selects the resource block 28 on which to transmit the sequence from among one or more resource blocks within the certain subchannel.

Other embodiments, by contrast, use the sequence 26 itself to indicate that the acknowledgement feedback 24 is from the wireless device 12A and/or differentiate the acknowledgement feedback from different wireless devices. In some embodiments, for example, the sequence 26 itself may be based on the identity 32A of the wireless device 12A. FIG. 1 correspondingly shows that the wireless device ID 32A may be an input to sequence generation or selection 33 at the wireless device 12A. In one such embodiment, the sequence 26 is a version of a base sequence, e.g., a phase-rotated version of the base sequence or a cyclically-shifted version of the base sequence. In this case, the versioning of the base sequence may be based on the identity 32A of the wireless device 12A. For example, the phase rotation or cyclic shift may be based on the device's identity 32A, e.g., such that different phase rotations or cyclic shifts of the same base sequence convey acknowledgment feedback for different wireless devices. In this case, then, the wireless device 12A may determine, based on the identity 32A of the wireless device 12A, a phase rotation or cyclic shift to apply to the base sequence, and then apply the determined phase rotation or cyclic shift to the base sequence. The peer wireless device 12B may correspondingly perform blind detection using different cyclic shifts or phase rotations of the base sequence in order to detect acknowledgement feedback from different wireless devices.

Alternatively or additionally to embodiments above, other embodiments herein concern how to indicate that the acknowledgement feedback 24 is intended for the peer wireless device 12B. In some embodiments in this regard, the sequence 26 itself is alternatively or additionally based on an identity (ID) 32B of the peer wireless device 10B, i.e., to which the sequence 26 is transmitted. The identity 32B may for instance be a physical layer identity of the peer wireless device 10B. The peer wireless device ID 32B may accordingly be an input to sequence generation or selection 33 at the wireless device 12A. In these embodiments, then, the peer wireless device 12B may detect any sequence that is intended for it by detecting any sequence that is based on its own identity 32B. This means that no explicit control signalling is needed in order for the peer wireless device 12B to monitor for sequences intended for it. For example, the peer wireless device 12B may generate or select a copy of the sequence 26 locally, attempt to match the local sequence with received sequences, and determine that any received sequence that matches the local sequence is intended for the peer wireless device 12B.

In some of these embodiments, any sequence intended for the peer wireless device 12B is the same, no matter from which wireless device the sequence is transmitted and no matter whether transmission of the sequence conveys positive or negative acknowledgement. This may be the case for instance where radio block selection for transmission of the sequence implicitly conveys the acknowledgement feedback as well as from which wireless device the sequence is received.

In other embodiments, any sequence intended for the peer wireless device 12B may be based on the same base sequence, with different versions of that base sequence respectively indicating acknowledgment feedback is conveyed from different wireless devices. For example, for conveying acknowledgement feedback 24 from the wireless device 12A to the peer wireless device 12B as in FIG. 1, the base sequence may be based on the identity 32B of the peer wireless device 12B, whereas a phase rotation or cyclic shift of the base sequence may be based on the identity 32A of the wireless device 12A.

In still other embodiments, the sequence 26 itself is alternatively or additionally based on a distance 36 between the wireless device 12A and the peer wireless device 12B, e.g., as estimated, measured, or otherwise obtained by the wireless device 12A. FIG. 1 correspondingly shows that this distance 36 may be an input to sequence generation or selection 33 at the wireless device 12A. For example, the sequence 26 may be a version (e.g., a phase-rotated version or a cyclic shifted version) of a base sequence. In this case, the base sequence may be based on the distance 36 between the wireless device 12A and the peer wireless device 12B.

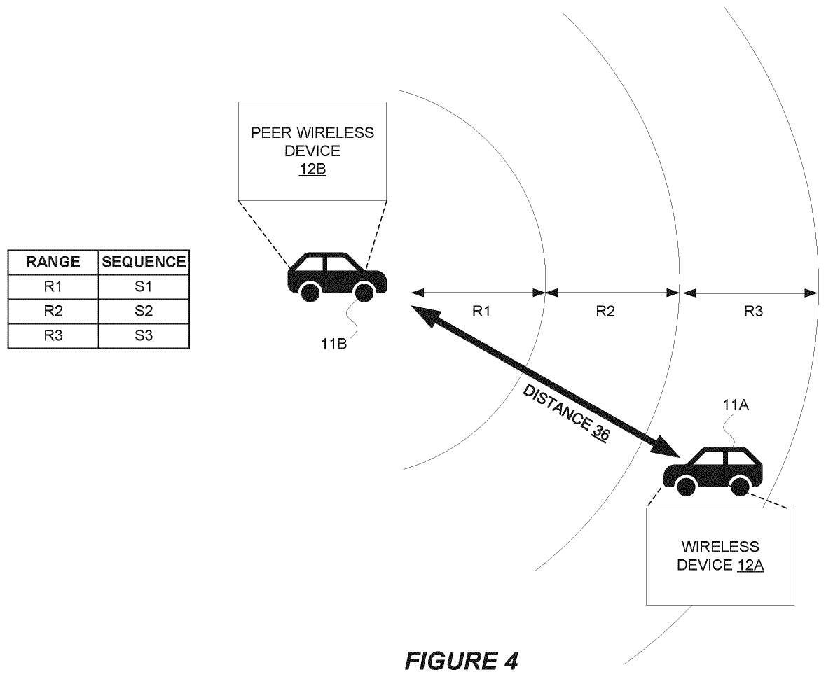

In some embodiments, for example, different (e.g., disjoint) ranges of distances are associated with different base sequences. FIG. 4 for instance shows different ranges R1, R2, and R3 of distances from the peer wireless device 12B. Range R1 is associated with base sequence S1, range R2 is associated with base sequence S2, and range R3 is associated with base sequence S3. The wireless device 12A determines within which of the different ranges R1, R2, and R3 the distance 36 between the wireless device 12A and the peer wireless device 12B is included. The wireless device 12A then determines, from among the different base sequences S1, S2, and S3, the base sequence that is associated with the determined range of distances. In this example of FIG. 4, then, the wireless device 12A determines that its distance 36 is included within range R3, so the wireless device 12A determines to use the base sequence S3 associated with that range R3. Note, then, that all wireless devices within the same range of distance from the peer wireless device 12B would use the same base sequence for conveying their acknowledgment feedback to the peer wireless device 12B. As described above in some embodiments, though, different wireless devices 12B within the same range may use different versions of that base sequence (e.g., via different phase rotations or cyclic shifts), or may transmit the base sequence on different resource blocks.

Basing the sequence 26 on the distance between the wireless devices in this or other ways may advantageously facilitate greater capacity for transmitting acknowledgement feedback to a given peer wireless device 12B. Indeed, only those wireless devices in the same distance range from the peer wireless device 12B share the same base sequence for conveying acknowledgment feedback to the peer wireless device 12B, as opposed to all the wireless devices sharing the same base sequence. Furthermore, the peer wireless device 12B may exploit the different ranges to deduce how many wireless devices (e.g., in a groupcast) are conveying positive acknowledgement and/or how many wireless devices are conveying negative acknowledgment on a range by range basis.

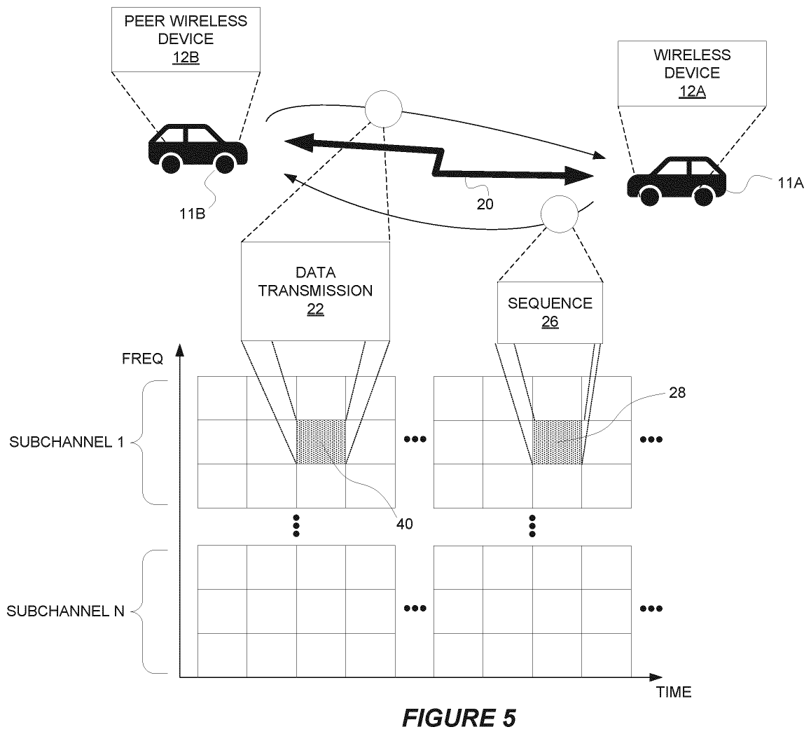

Alternatively or additionally to the embodiments above, the wireless device 12A may be configured to transmit the sequence 26 on the same subchannel as the subchannel on which the data transmission 22 is received. As shown in FIG. 5, for example, N subchannels are defined, with each subchannel comprises one or more resource blocks. The wireless device 12A receives the data transmission 22 on subchannel 1, i.e., on a resource block 40 within subchannel 1. According to these embodiments, then, reception of the data transmission 22 on subchannel 1 dictates that the wireless device 12A transmit the sequence 26 conveying acknowledgement feedback 24 for that data transmission 22 also on subchannel 1.

Note that any of the above embodiments from FIGS. 1-4 may be governed or otherwise configured by control signalling that the wireless device 12A receives from the peer wireless device 12B and/or a radio network node 14 within the RAN 10A. For example, in some embodiments, the wireless device 12A receives control signalling indicating one or more rules according to which the wireless device 12A is to: (i) generate the sequence 26; (ii) select a resource block 28 in which to transmit the sequence 26; and/or (iii) select a subchannel on which to transmit the sequence 26. The one or more rules may for instance specify the manner in which the wireless device 12A is to do so, as described above. The wireless device 12A may correspondingly apply the one or more rules to generate the sequence 26, select the resource block 28, and/or select the subchannel.

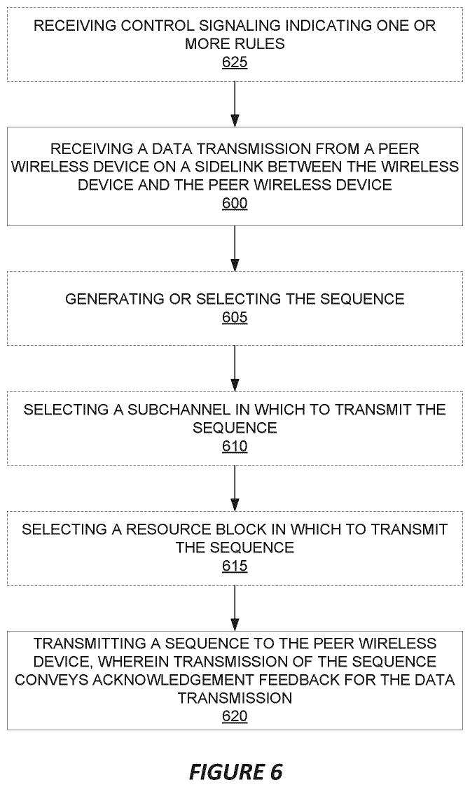

In view of the above modifications and variations, FIG. 6 depicts a method performed by a wireless device 12A in accordance with particular embodiments. The method includes receiving a data transmission 22 (e.g., a V2X data transmission) from a peer wireless device 12B on a sidelink 20 between the wireless device 12A and the peer wireless device 12B (Block 600). The method also includes transmitting a sequence 26 to the peer wireless device 12B, where transmission of the sequence 26 conveys acknowledgement feedback 24 for the data transmission 22 (Block 620).

In some embodiments, the sequence 26 is based on an identity 32B of the peer wireless device 12B. For example, where the sequence 26 is a version of a base sequence, the base sequence may be based on the identity 32B of the peer wireless device 12B. Alternatively or additionally, the sequence 26 may be based on an identity 32A of the wireless device 12A. For example, where the sequence 26 is a phase-rotated version or cyclic shifted version of a base sequence, the phase rotation or cyclic shift of the base sequence may be based on the identity 32A of the wireless device 12A. Alternatively or additionally, the sequence 26 may be based on a distance 36 between the wireless device 12A and the peer wireless device 12B. For example, where the sequence 26 is a version of a base sequence, the base sequence may be based on such distance 36. In any of these embodiments, then, the method may further comprise generating or selecting the sequence 26, e.g., as described above (Block 605).

In some embodiments, the method alternatively or additionally comprises selecting a subchannel in which to transmit the sequence 26 (Block 610). For example, the wireless device 12A may select to transmit the sequence 26 on the same subchannel as the subchannel on which the data transmission 22 was received. Or, the subchannel selection may be based on a prioritization or indexing of multiple possible subchannels.

In some embodiments, the method alternatively or additionally comprises selecting a resource block 28 on which to transmit the sequence 26 (Block 615). For example, the resource block selection may be based on an identity 32A of the wireless device 12A. Alternatively or additionally, the selection may be based on the acknowledgement feedback 24 to be conveyed, e.g., such that transmission of the sequence 26 on a certain resource block conveys the acknowledgement feedback 24. For example, the wireless device 12A may select the resource block 28 from between two candidate resource blocks respectively associated with positive acknowledgement and negative acknowledgement, depending on whether the acknowledgement feedback to be conveyed positively or negatively acknowledges the data transmission 22. Regardless, the wireless device 12A may select the resource block 28 among multiple resource blocks across multiple subchannels, wherein each subchannel includes one or more resource blocks. Or, the wireless device 12A in other embodiments may select the resource block among multiple resource blocks in the certain subchannel (e.g., selected as described above).

Alternatively or additionally, the method may comprise receiving control signalling indicating one or more rules according to which the wireless device 12A is to: (i) generate the sequence 26; (ii) select a resource block 28 in which to transmit the sequence 26; and/or (iii) select a subchannel on which to transmit the sequence 26 (Block 625).

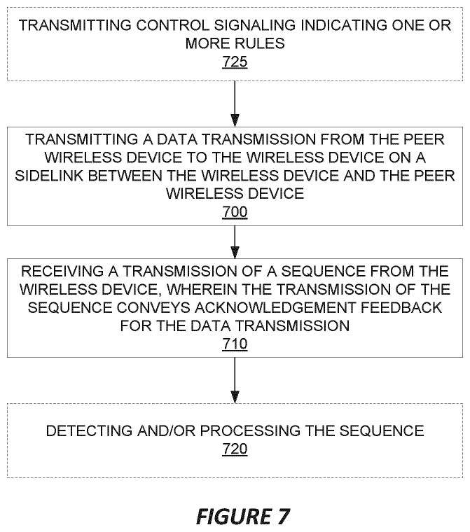

FIG. 7 depicts a method performed by a peer wireless device 12B in accordance with other particular embodiments. The method includes transmitting a data transmission 22 (e.g., a V2X data transmission) from the peer wireless device 12B to a wireless device 12A on a sidelink 20 between the wireless device 12A and the peer wireless device 12B (Block 700). The method also includes receiving, from the wireless device 12A, a transmission of a sequence 26, where the transmission of the sequence 26 conveys acknowledgment feedback 24 for the data transmission 22 (Block 710).

In some embodiments, the sequence 26 is based on an identity 32B of the peer wireless device 12B. For example, where the sequence 26 is a version of a base sequence, the base sequence may be based on the identity 32B of the peer wireless device 12B. Alternatively or additionally, the sequence 26 may be based on an identity 32A of the wireless device 12A. For example, where the sequence 26 is a phase-rotated version or cyclic shifted version of a base sequence, the phase rotation or cyclic shift of the base sequence may be based on the identity 32A of the wireless device 12A. Alternatively or additionally, the sequence 26 may be based on a distance 36 between the wireless device 12A and the peer wireless device 12B. For example, where the sequence 26 is a version of a base sequence, the base sequence may be based on such distance 36. In any of these embodiments, then, the method may further comprise detecting and/or processing the sequence 26, e.g., based on the above (Block 720).

In some embodiments, the wireless device 12B may receive the sequence 26 on the same subchannel as the subchannel on which the data transmission 22 was transmitted.

In some embodiments, the wireless device 12B may receive the sequence 26 a resource block 28. For example, the resource block 28 on which the sequence is received may be based on an identity 32A of the wireless device 12A. Alternatively or additionally, the resource block 28 on which the sequence is received may be based on the acknowledgement feedback 24 to be conveyed, e.g., such that transmission of the sequence 26 on a certain resource block conveys the acknowledgement feedback 24. For example, two candidate resource blocks may be respectively associated with positive acknowledgement and negative acknowledgement, depending on whether the acknowledgement feedback to be conveyed positively or negatively acknowledges the data transmission 22.

Alternatively or additionally, the method may comprise transmitting control signalling indicating one or more rules according to which the wireless device 12A is to: (i) generate the sequence 26; (ii) select a resource block 28 in which to transmit the sequence 26; and/or (iii) select a subchannel on which to transmit the sequence 26 (Block 725).

Although not shown, the method may further includes processing the acknowledgement feedback 24 as conveyed and performing a new data transmission or a re-transmission of the data transmission 22 depending on the acknowledgment feedback 24.

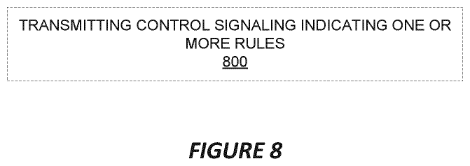

FIG. 8 depicts a method performed by a radio network node 14 in accordance with other particular embodiments. The method includes transmitting control signalling indicating one or more rules according to which the wireless device 12A is to: (i) generate the sequence 26; (ii) select a resource block 28 in which to transmit the sequence 26; and/or (iii) select a subchannel on which to transmit the sequence 26 (Block 800).

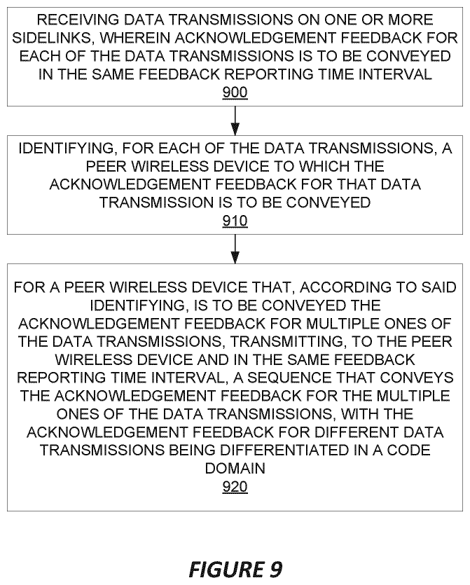

FIG. 9 depicts a method performed by a wireless device 12A in accordance with other particular embodiments. The method includes receiving data transmissions on one or more sidelinks, wherein acknowledgement feedback for each of the data transmissions is to be conveyed in the same feedback reporting time interval (Block 900). The method also includes identifying, for each of the data transmissions, a peer wireless device to which the acknowledgement feedback for that data transmission is to be conveyed (Block 910). The method may further include, for a peer wireless device that, according to said identifying, is to be conveyed the acknowledgement feedback for multiple ones of the data transmissions, transmitting, to the peer wireless device and in the same feedback reporting time interval, a sequence that conveys the acknowledgement feedback for the multiple ones of the data transmissions, with the acknowledgement feedback for different data transmissions being differentiated in a code domain (Block 920).

For example, in some embodiments, the transmitted sequence comprises a phase rotated version of a base sequence. In this case, different phase rotations of the base sequence may convey different combinations of the acknowledgement feedback for the multiple ones of the data transmissions.

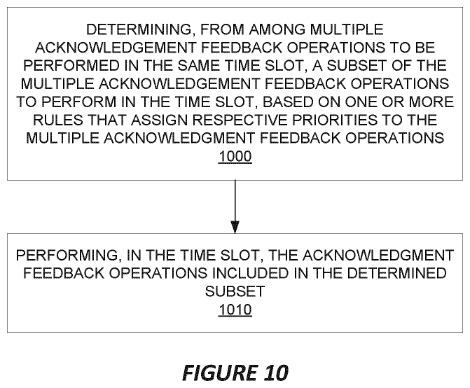

FIG. 10 depicts a method performed by a wireless device 12A in accordance with other particular embodiments. The method includes determining, from among multiple acknowledgement feedback operations to be performed in the same time slot, a subset of the multiple acknowledgement feedback operations to perform in the time slot, based on one or more rules that assign respective priorities to the multiple acknowledgment feedback operations (Block 1000). The method may also include performing, in the time slot, the acknowledgment feedback operations included in the determined subset (Block 1010).

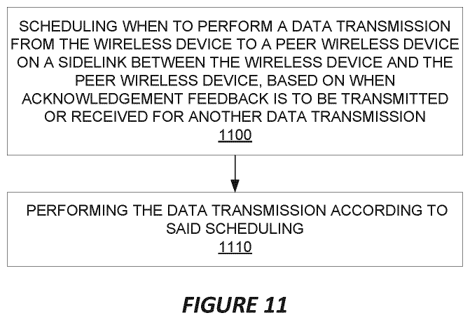

FIG. 11 depicts a method performed by a wireless device 12A in accordance with other particular embodiments. The method includes scheduling when to perform a data transmission from the wireless device to a peer wireless device on a sidelink between the wireless device and the peer wireless device, based on when acknowledgement feedback is to be transmitted or received for another data transmission (Block 1100). The method may also include performing the data transmission according to said scheduling (Block 1110).

Embodiments herein also include corresponding apparatuses. Embodiments herein for instance include a wireless device configured to perform any of the steps of any of the embodiments described above for the wireless device.

Embodiments also include a wireless device comprising processing circuitry and power supply circuitry. The processing circuitry is configured to perform any of the steps of any of the embodiments described above for the wireless device. The power supply circuitry is configured to supply power to the wireless device.

Embodiments further include a wireless device comprising processing circuitry. The processing circuitry is configured to perform any of the steps of any of the embodiments described above for the wireless device. In some embodiments, the wireless device further comprises communication circuitry.

Embodiments further include a wireless device comprising processing circuitry and memory. The memory contains instructions executable by the processing circuitry whereby the wireless device is configured to perform any of the steps of any of the embodiments described above for the wireless device.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node configured to perform any of the steps of any of the embodiments described above for the radio network node.

Embodiments also include a radio network node comprising processing circuitry and power supply circuitry. The processing circuitry is configured to perform any of the steps of any of the embodiments described above for the radio network node. The power supply circuitry is configured to supply power to the radio network node.

Embodiments further include a radio network node comprising processing circuitry. The processing circuitry is configured to perform any of the steps of any of the embodiments described above for the radio network node. In some embodiments, the radio network node further comprises communication circuitry.

Embodiments further include a radio network node comprising processing circuitry and memory. The memory contains instructions executable by the processing circuitry whereby the radio network node is configured to perform any of the steps of any of the embodiments described above for the radio network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

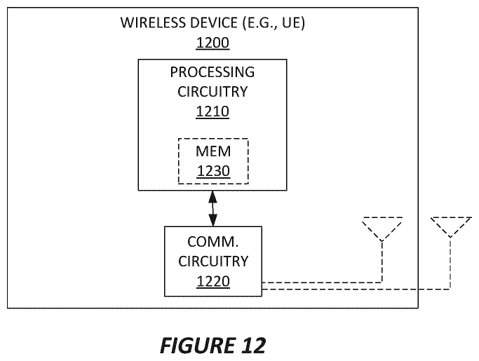

FIG. 12 for example illustrates a wireless device 1200 (e.g., wireless device 12A or peer wireless device 12B) as implemented in accordance with one or more embodiments. As shown, the wireless device 1200 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the wireless device 1200. The processing circuitry 1210 is configured to perform processing described above, such as by executing instructions stored in memory 1230. The processing circuitry 1210 in this regard may implement certain functional means, units, or modules.

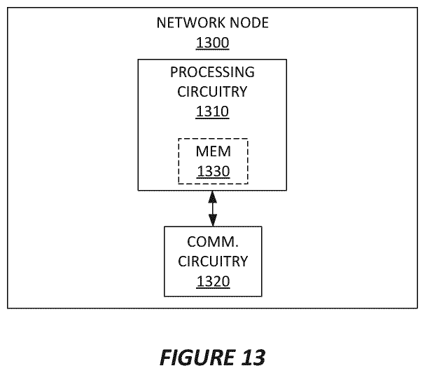

FIG. 13 illustrates a network node 1300 (e.g., radio network node 14) as implemented in accordance with one or more embodiments. As shown, the network node 1300 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

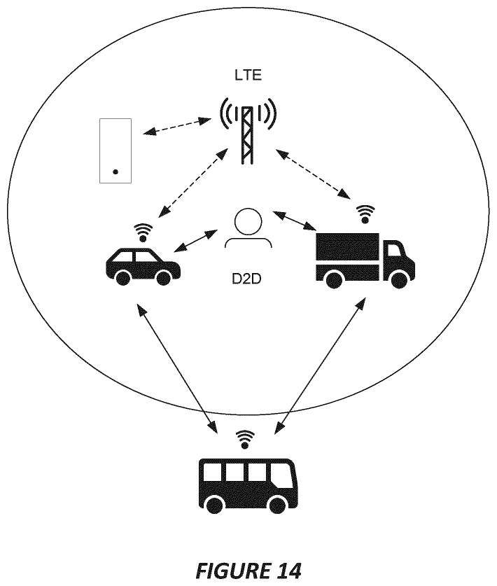

Some embodiments herein are applicable in a context based on Long Term Evolution (LTE) V2X, which was first specified by Third Generation Partnership Project (3GPP) in Release 14 and was enhanced in Release 15. LTE V2X consists of basic features and enhancements that allow for vehicular communications. One of the most relevant aspects is the introduction of direct vehicle-to-vehicle (V2V) communication functionalities. The specifications support other types of vehicle-to-anything (V2X) communications, including V2P (vehicle-to-pedestrian or pedestrian-to-vehicle), V21 (vehicle-to-infrastructure), etc., as shown in FIG. 14.

These direct communication functionalities are built upon LTE D2D (device-to-device), also known as ProSe (Proximity Services), as first specified in the Release 12 of LTE, and include many important enhancements targeting the specific characteristics of vehicular communications. For example, LTE V2X operation is possible with and without network coverage and with varying degrees of interaction between the UEs (user equipment) and the NW (network), including support for standalone, network-less operation.

LTE V2X mainly targets basic road safety use cases like forward collision warning, emergency braking, roadworks warning, etc. Vehicles UE supporting V2X applications can exchange their own status information such as position, speed and heading, with other nearby vehicles, infrastructure nodes and/or pedestrians. The typical messages sent by the vehicles are Co-operative Awareness Message (CAM) and Decentralized Environmental Notification Message (DENM), defined by ETSI, or Basic Safety Message (BSM), defined by the SAE (Society of the Automotive Engineers).

Alternatively or additionally, some embodiments herein are applicable in a context based on a new radio (NR) version developed for V2X communications. The NR V2X will mainly target more advanced V2X services than basic road safety services, which can be categorized into four use case groups: vehicles platooning, extended sensors, advanced driving, and remote driving. The advanced V2X services would require enhancing the current NR system and a new NR sidelink design to meet stringent requirements in terms of latency and reliability. NR V2X system is also expected to have higher system capacity and better coverage and to allow for easy extension to support the future development of further advanced V2X services and other services.

One of the salient features of NR V2X is the support of unicast and groupcast (also known as multicast) transmissions at radio layers, in addition to supporting broadcast transmissions as the case of LTE V2X. Unicast means a pair of UEs communicate with each other while groupcast refers to a scenario in which a group of UEs communicate with each other.

Some embodiments herein are applicable for an adaptive retransmission scheme called Hybrid Automatic Repeat reQuest (HARQ), particularly that scheme which is specified in 3GPP. According to this scheme the receiver of a packet sends back a positive (ACK) or a negative (NACK) acknowledgement to the sender, depending on whether the receiver has decoded the packet successfully or unsuccessfully, respectively. If it is an ACK the sender will transmit a new packet and if it is a NACK the sender will retransmit either the same version or a different version of the initial packet. There can be multiple retransmission attempts for a single data packet. Heretofore, the HARQ has been most suitable for unicast and groupcast transmissions because these casting modes often have some ways of identifying the source and the destination of a packet (e.g. source and destination IDs), which facilitates both the feedbacks and data retransmissions. HARQ has heretofore often not been used in broadcast mode where either feedback and retransmission are not of interest or their benefits cannot outweigh the associated complexity due to many participants.

An important part of the HARQ mechanism is the HARQ feedback. For that, there is a clear difference between the uplink/downlink (i.e., the Uu interface) and the sidelink.

In NR uplink and downlink, the transmission of HARQ feedback is scheduled by the gNB, which is informed to the UE via the downlink control information (DCI). In the uplink, the ACK/NACK are sent in the physical uplink control channel (PUCCH). There are multiple PUCCH formats to send the ACK/NACK, each for a different purpose. Among those, the most relevant format for the current disclosure is the PUCCH format 0.

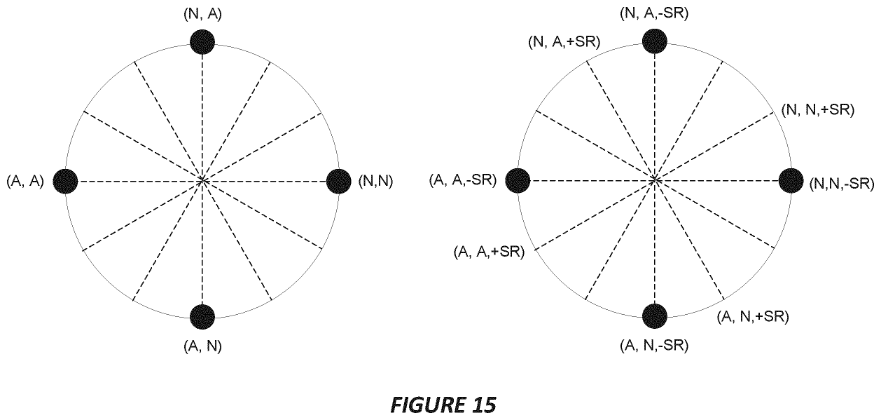

PUCCH format 0 is one of the short PUCCH formats in NR and is capable of transmitting up to two bits. It is used for sending HARQ feedback and scheduling requests. The basis of PUCCH format 0 is sequence selection: the information bit(s) selects the sequence to transmit. The transmitted sequence is generated by different phase rotations of the same underlying length-12 base sequence. Thus, the phase rotation carries the information. In other words, the information selects one of several phase-rotated sequences. Examples of PUCCH format 0 is given in FIG. 15.

In particular, FIG. 15 shows examples of phase rotations as a function of HARQ acknowledgements (A, N for ACK, NACK) and scheduling request (SR) in PUCCH format 0. Twelve different phase rotations are defined for the same base sequence, providing up to 12 different orthogonal sequences from each base sequence. A linear phase rotation in the frequency domain is equivalent to applying a cyclic shift in the time domain, hence, the term “cyclic shift” is sometimes used with an implicit reference to the time domain.

PUCCH format 0 is typically transmitted at the end of a slot and spans one or two OFDM symbols. However, it is possible to transmit PUCCH format 0 also in other positions within a slot.

For NR SL unicast and groupcast, HARQ can be used to improve transmission reliability. A new physical channel, termed Physical Sidelink Feedback Channel (PSFCH), conveys HARQ feedback (i.e., ACK and/or NACK) from a receiver to a transmitter. Each PSFCH provides HARQ feedback for a physical sidelink shared channel (PSSCH). The PSSCH typically carries a data packet and is scheduled by an associated physical sidelink control channel (PSCCH). In case of groupcast, there are two options to send the HARQ feedback. In Option 1, the receiver UE transmits only HARQ NACK. For this option it is supported that all the receiver UEs share a PSFCH. Furthermore, in some embodiments, a subset of the receiver UEs share a PSFCH. In Option 2, a receiver UE transmits HARQ ACK/NACK. For this option it is supported that each receiver UE uses a separate PSFCH for HARQ ACK/NACK. Furthermore, in some embodiments, all or a subset of receiver UEs share a PSFCH for ACK transmission and another PSFCH for NACK transmission.

In addition to the above two options, the transmitter-receiver distance may be used as a means to simplify the overall HARQ mechanism for groupcast. Specifically, at least for Option 1 above, a UE transmits HARQ feedback for a PSSCH if the distance from that UE to the transmitter UE of the PSSCH is smaller than or equal to the communication range requirement of the message carried in the PSSCH. Otherwise, the UE does not transmit HARQ feedback for the PSSCH.

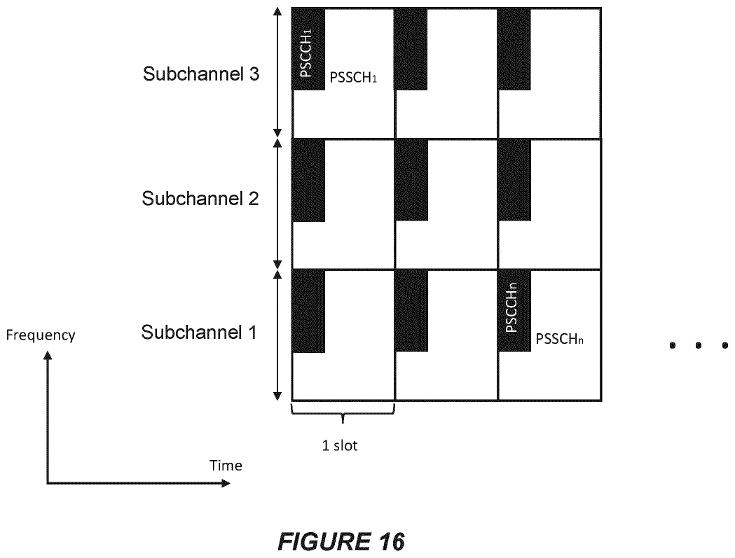

An NR sidelink resource pool consists of radio resources spanning both time and frequency domains. In the frequency domain, a resource pool is divided into multiple subchannels (or subbands), each subchannel consists of a number of contiguous resource blocks. A transmission in the sidelink will use an integer number of subchannels. In the time domain, the resource pool may consist of non-contiguous slots, i.e., there can be non-sidelink slots (e.g., uplink slots or special-purpose slots for transmitting certain signals) between two consecutive sidelink slots. FIG. 16 illustrates subchannels in a sidelink resource pool. Specifically, FIG. 16 shows an example of an NR sidelink resource pool consisting of 3 subchannels. PSCCHx and PSSCHx denotes a physical sidelink control channel and its corresponding physical sidelink shared channel, respectively.

Some embodiments herein advantageously address problems with HARQ feedback in the context of sidelink communication. In NR uplink and downlink, the gNB schedules orthogonal resources for the transmission of HARQ feedback from/to the UEs. Thanks to this coordination, different HARQ feedbacks are always distinguishable, both at the gNB side and at the UE side. Unlike the above situation in the uplink and downlink, the distributed nature of the sidelink makes it very challenging for the design of HARQ feedback mechanisms. Specifically, the following issues need to be addressed in an efficient manner (e.g., with minimal signaling overhead) without the gNB's coordination: (i) Resource selection for the HARQ feedback of the UEs; (ii) Physical format of the PSFCH; and (iii) Association of a HARQ feedback with its corresponding data transmission.

Some of the above matters may be at least partially addressed by the following: (i) NR sidelink supports a sequence-based PSFCH format that uses one last symbol available for sidelink in a slot. The PSFCH sequence uses PUCCH format 0 as a starting point; (ii) At least for the case when the PSFCH in a slot is in response to a single PSSCH, implicit mechanism is used to determine at least frequency and/or code domain resource of PSFCH, within a configured resource pool; and (iii) PSFCH resources are (pre)configured periodically with a period of N slot(s), where N is configurable from the set N={1,2,4}. This means the resources to send the PSFCH are only available in every Nth sidelink slots.

Despite the above, there are still multiple problems to be solved.

P1: Details of the implicit mechanism to determine resources for a PSFCH. The resource pool is divided into subchannels and a PSSCH is transmitted using an integer number of consecutive subchannels. Heretofore, a question remains which subchannels should be used to send the PSFCH for that PSSCH. Moreover, for a PSFCH format similar to the PUCCH format 0, which occupies one RB, it has heretofore been unclear how a UE would select an RB for the PSFCH.

P2: How to accommodate the PSFCHs from multiple UEs in groupcast. One approach would be to use different phase rotations of the same base sequence to differentiate the PSFCH from different UEs, but that would come with the price of sending only one bit feedback for each UE and would still limit the maximum number of UEs in a groupcast to 12. These limitations are not always desirable. This approach may be regarded as an extension of PUCCH format 0 design.

Several problems arise due to N=2 and 4 (i.e., due to the resources for PSFCH not available in every sidelink slot) and are exaggerated by the fact that a sidelink resource pool may contain non-contiguous slots.

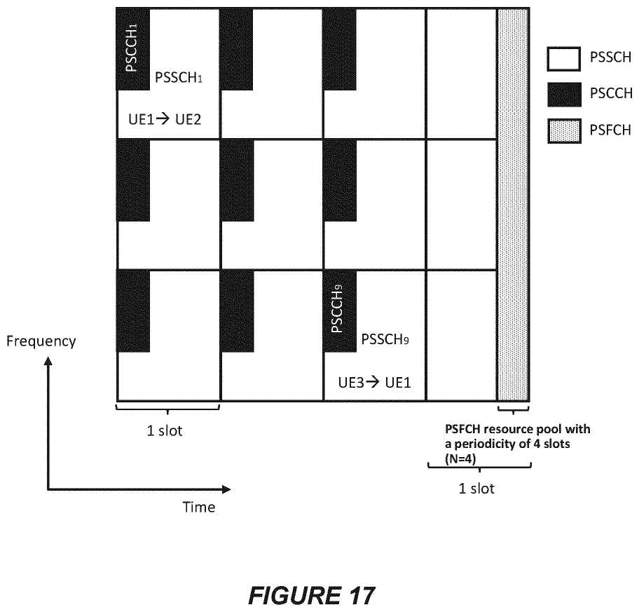

P3: (PSFCH transmission/reception overlap): In the same slot, a UE needs to simultaneously transmit and receive HARQ feedbacks. An example is given in FIG. 17 for PSFCH transmission/reception overlap or half-duplex issue of PSFCH transmissions, with PSFCH resources configured with period of N=4 slots. At the final slot shown FIG. 17, where the PSFCH resources are available, UE1 needs to send HARQ feedback to UE3 and to receive HARQ feedback from UE2 simultaneously. Usually this simultaneous transmission and reception is not possible due to hardware limitations, known as the half-duplex issue. A potential solution would be letting the UE drop either the feedback transmission or the feedback reception. However, the criteria for dropping needs to be carefully designed, and in any case dropping would clearly reduce the performance of the HARQ mechanism.

P4: (PSFCH transmission with multiple HARQ feedbacks): In the same slot, a UE1 needs to send multiple HARQ feedbacks for different PSSCHs. A potential solution would be to transmit only one of the feedbacks. However, such a solution might incur a loss in performance. Another potential solution would be multiplexing multiple PSFCHs in frequency domain (each PSFCH is for one feedback and occupies a resource block like the PUCCH format 0) and sending the multiplexed signal. However, such a transmission is not advisable because the combined signal has undesired properties. For example, intermodulation across the multiplexed PSFCH sequences will hamper some desired properties of the individual sequences. In addition to the mentioned challenges, different PSSCHs can be transmitted on different subchannels, complicating the resource selection for the PSFCH.

Additionally, a good design needs to solve the above problems in an efficient way. In particular, the design needs to balance the impact of the solutions to the individual problems.

Certain aspects of the present disclosure and their embodiments may provide solutions to these or other challenges. A set of solutions to the problems described above may be provided herein. For example, various methods for implicitly determining PSFCH resources and sequence are proposed (for both unicast and groupcast), as follows:
Methods for the UEs to determine radio resources and generate sequences for the PSFCH. The methods utilize the ID of the transmitter UE (i.e., the UE transmitting the PSSCH), the ID of the receiver UE (i.e., the UE receiving the PSSCH and hence transmitting the PSFCH), and the transmitter-receiver distance in various ways.
A method for sending multiple HARQ feedback bits in one PSFCH that make use of relation of the receivers of the feedback bits and the related subchannels.
Methods to prioritize a PSFCH-related operation (i.e., transmission or reception of HARQ feedback) over another, based on the nature of the related HARQ feedback information.
Methods of selecting resources to avoid simultaneous transmission and reception of PSFCH and to avoid simultaneous PSFCH transmissions. Some embodiments generally perform one or more of:
Using TX UE ID to select the PSFCH sequence or base sequence.
Using RX UE ID to randomize the selected resource blocks for PSFCH.
Utilizing the transmitter-receiver distance to improve the distinguishability of HARQ feedbacks in groupcast (increasing the number of orthogonal resources for PSFCH in a groupcast).
Exploiting the relation between intended receivers of the HARQ feedback bits to determine whether to combine the feedback bits in a single PSFCH.
Prioritization of PSFCH based on whether it is for ACK or NACK.
Utilizing information about PSFCH transmission to avoid overlapping of transmission with transmission or transmission with reception of HARQ feedbacks.

Certain embodiments may provide one or more of the following technical advantage(s):
Maximizing the distinguishability of the ACK from the NACK, which are transmitted from the same UE or from different UEs.
Maximizing the number of UEs that can send distinguishable HARQ feedbacks to the same UE (i.e., the groupcast scenario).
Avoiding or minimizing the loss due to the problems caused by the configurations in which resources for PSFCH are not available in every sidelink slot, i.e., the problem of simultaneous transmission and reception of PSFCH, the problem of transmitting multiple HARQ feedbacks in the same slot (see problems P3, P4)
All advantages above come with little or no extra signaling overhead exchanged between UEs. In other words, the signaling is implicit.

Some embodiments below are described in the context of sidelink V2X communications. However, any of the embodiments are applicable to direct communications between UEs, in other scenarios involving device-to-device (D2D) communications.

The disclosure includes several solutions to the problems listed above (P1-4). A solution can address more than one problem and the solutions can be combined in various meaningful ways. A solution can be applied to either unicast or groupcast or both. Further, the solutions apply both when there exist ACK and NACK and when there exists only one of them (e.g., only NACK in Option 1 above).

The description below assumes that each sequence-based PSFCH occupies one RB (i.e., length-12 sequence, mapped to 12 subcarriers), as with PUCCH format 0, but the solutions are applicable to any sequence length.

The following notations are used in the description below. PSFCH-ACK denotes a PSFCH carrying an ACK and PSFCH-NACK denotes a PSFCH carrying a NACK. Transmitter UE (equivalently TX UE) denotes the UE transmitting a data packet (equivalently a PSSCH) and receiver UE (equivalently RX UE) denotes a UE receiving the data packet. Hence RX UE is the UE who sends the PSFCH.

### Solution 1 (Determination of Resources and Sequence for PSFCH in Unicast):

This solution addresses problem P1 and P2. Separate (disjoint) resource blocks (RBs) are allocated to the PSFCH-ACK and the PSFCH-NACK of the same PSSCH. The location of these RBs depends on the identity of the RX UE. Further, the PSFCH-ACK and the PSFCH-NACK use the same sequence, which is generated (or selected) based on the identity of the TX UE.

The advantages of this solution are as follows. First, separating PSFCH-ACK and PSFCH-NACK into different RBs allows a clearer differentiation of the ACK and the NACK at the TX UE than using different phase rotations as with PUCCH format 0. Second, using RX UE ID in selecting the RBs allows for randomization of the interference caused to each PSFCH, avoiding the scenario wherein an RB is selected for many PSFCHs and therefore heavily interfered. It also helps the TX UE identify from which RX UE the PSFCH comes, should there be multiple PSFCHs sent to the same TX UE in the same slot (note that for unicast typically the TX UE knows the RX UE ID and vice versa). Third, using TX UE ID in selecting the PSFCH sequence allows the TX UE to detect the desired PSFCH without requiring an explicit signaling in the PSFCH or elsewhere (e.g., the TX UE can generate a copy of the sequence locally and matches the local sequence with the received sequence).

### Solution 2 (Determination of Sequence for PSFCH in Groupcast):

This solution addresses problem P1 and P2. The base sequence for PSFCH is generated (or selected) based on the identity of the TX UE and the RX UE ID is used to select a phase rotation (equivalently a cyclic shift) of the base sequence to produce the PSFCH sequence. If both ACK and NACK are allowed for HARQ feedback, the PSFCH-ACK and the PSFCH-NACK share the same base sequence but use disjoint resource blocks.

The advantages of this solution are as follows: Without additional signaling, the TX UE knows which base sequence is used for the PSFCH. The TX UE can just do blind detection using different cyclic shifts of the base sequence to figure out how many ACKs and NACKs are being received. Note that the PSFCHs from different RX UEs are distinguishable at the TX UE since the cyclic shift each RX UE uses for its PSFCH is chosen based on RX UE ID.

### Solution 3 (Determination of Resources and Sequence for PSFCH in Groupcast)

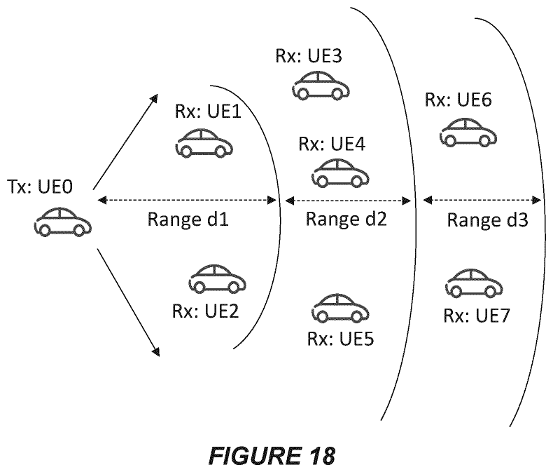

This solution addresses problem P1 and P2. The space around the TX UE is divided into disjoint range intervals (or distance ranges). Each range interval is bounded by an inner circle and an outer circle centered at the TX UE. For example, the area around at TX UE is divided into four intervals at distance ranges of (0,150 m], (150 m, 300 m], (300 m, 450 m], and [beyond 450 m] from the TX UE. All RX UEs belonging to the same range interval use the same base sequence for their PSFCHs. The PSFCH base sequence is generated (or selected) based on a combination of the identity of the TX UE and the distance range to which the RX UEs belong. The RX UE ID is used to select a phase rotation (equivalently a cyclic shift) of the base sequence to form the PSFCH sequence of that RX UE. An example is given in FIG. 18.

In FIG. 18, the set of RX UEs are divided into different groups, each group having the same distance range to the TX UE. In this figure, RX UE1 and RX UE2 belong to the same group since their distances to the TX UE belong to the same range d1. Similarly, RX UE3, RX UE4, and RX UE5 belong to another group since their distances to the TX UE belong to the same range d2, and so on. According to Solution 3, RX UE1 and RX UE2 share the same base sequence for their PSFCHs, and the ID of each RX UE is used to select the phase rotation of that base sequence. The same principle applies to other groups of UEs.

One advantage of this solution is that it helps accommodate more receivers in a groupcast. Specifically, only those RX UEs in the same distance range share the same base sequence for PSFCH (because the base sequence is selected based on the distance range), as opposed to the case where all RX UEs in the groupcast share the same base sequence. Furthermore, the solution helps the TX UE knows not only how many RX UEs in the groupcast are sending ACK and/or NACK but also how many are sending ACK and/or NACK for each individual distance range. Similar to the preceding solutions, this solution does not require extra signaling.

### Solution 4 (Multiple HARQ Feedbacks in One PSFCH)

This solution addresses problem P1 and P4. When there are multiple HARQ feedbacks (i.e., ACK and/or NACK) to be sent from a RX UE in the same slot, each feedback targets an individual PSSCH, the RX UE will check the set of the TX UEs for which the feedbacks are targeting (i.e., the UE which sent the PSSCHs), and do the following.

If there is only one TX UE in the set (i.e., all feedbacks target the same TX UE) then the feedback bits are combined and sent in one single PSFCH. Different combinations of the feedback bits are distinguished in the code domain, for example, by phase rotations of the PSFCH sequence. For instance, using phase rotations in the same way as with PUCCH 0, one can signal 3 bits in one PSFCH (i.e., 8 combinations of feedback bits such as (ACK, ACK, ACK), (ACK, ACK, NACK), and so on). Furthermore, if there are more feedback bits to be combined than can be supported by the phase rotation then some of the bits can be discarded. The rule for discarding the feedback bits can be time-first (i.e., the bits are ordered according to the transmission time of the corresponding PSSCH), or based on the priorities of the PSSCHs, or a combination of transmission time and priority.

In some embodiments, if the PSSCHs are transmitted in different subchannels, one of the subchannel will be used to transmit the PSFCH. The rule to select this subchannel can be (pre)configured, e.g., the one with lowest index is selected, or the one where the PSSCH with highest priority was transmitted. In the case the PSSCHs are transmitted in the same subchannel, that very subchannel is used for the PSFCH.

Otherwise (i.e., if the HARQ feedbacks target different TX UEs) then one of the feedbacks is sent in the PSFCH, e.g., the HARQ feedback associated with the highest-priority PSSCH is sent (see further Solution 6).

The advantage of this solution that is it improves the capacity of the HARQ feedback. Specifically, it allows sending multiple HARQ feedbacks in one PSFCH but does not require explicit signaling between the TX UE and the RX UE about which subchannel to be used. Furthermore, the solution can be particularly useful if HARQ feedback per code block group (CBG) is supported, which typically requires more feedback bits per data packet than when it is not supported. In this case each PSSCH represents a code block or a code block group.

### Solution 5 (Prioritization in Subchannel Selection for PSFCH)

To transmit a PSFCH, a UE prioritizes using the same subchannel as the subchannel of the targeting PSSCH. The advantage of this solution is it avoids the need to signal the subchannel index that a RX UE will use for a PSFCH. Hence, this solution addresses problem P1. Note that when there are multiple HARQ feedbacks, in certain cases the feedbacks can be combined and sent in one of the subchannel as described in Solution 5.

### Solution 6 (Prioritization in HARQ Feedback Transmission/Reception)

This solution addresses problem P3 and P4. When a UE needs to perform multiple PSFCH-related operations at the same time (e.g., to simultaneously transmit and receive PSFCHs or to transmit multiple feedbacks at the same time) the UE can prioritize one of the operations based on a certain rule. As one example, in groupcast, when the UE needs to send an ACK and a NACK in the same slot, the UE prioritizes the NACK transmission. This is because for the transmitter of a data packet, it is most important to know if there is any receiver who has failed to decode the packet (equivalently if there is any NACK) in order to perform a retransmission. It is also common that the transmitter wants to know how many NACKs are there.

As another example, in unicast, when the UE needs to send a NACK and to receive another PSFCH in the same slot, the UE prioritizes the PSFCH reception. This because, in unicast, no reception of HARQ feedback is typically interpreted as a NACK.

In another example, in unicast, when the UE needs to send an ACK and a NACK in the same slot, the UE prioritizes the ACK transmission. This is because, in unicast, no reception of HARQ feedback is typically interpreted as a NACK.

### Solution 7 (Resource Selection for PSFCH)

This solution addresses problem P3 and P4. Resource selection algorithm takes into account future PSFCH transmission and/or reception. In this solution, knowing the time slot that a UE needs to send or receive a HARQ feedback, the same UE or another UE will exclude certain set of resources from the set of available resources when searching for resources for data transmission. As a result, the situation of PSFCH transmission/reception overlap or simultaneous transmission of multiple PSFCHs can be avoided.

### Combinations and Applicability of Solutions

As mentioned earlier, the solutions can be combined in various meaningful ways. A solution can be applied to either unicast or groupcast or both. For example, referring to Solutions 1 to 7 described above:
Solutions 1, 4, 5, 6, 7 may be applicable to unicast.
Solutions 2, 3, 5, 6, 7 may be applicable to groupcast.

### EXAMPLES OF EMBODIMENTS FOR THE ABOVE SOLUTIONS

### Embodiments for Solution 1

According to this embodiment, a UE selects resources for transmission of a sequence-based PSFCH in response to a PSSCH by:
Selecting non-overlapping resource blocks (RBs) for the PSFCH-ACK and for the PSFCH-NACK, wherein the locations of the RBs are selected based on an identity of the UE according to a rule.
Using the same sequence for the PSFCH-ACK and the PSFCH-NACK, wherein the sequence is generated based on an identity of the transmitter UE of the PSSCH according to a rule.

In some embodiments, the resources for transmission of the PSFCH include resources in any combination of time, frequency, space, and code domain.

In some embodiments, the identity of the UE is the physical layer identity of the UE.

In some embodiments, the selected RBs comprises two consecutive RBs.

In some embodiments, the identity of the transmitter UE of the PSSCH is the physical layer ID of the transmitter UE of the PSSCH, and the ID is indicated in the PSCCH scheduling the PSSCH.

In some embodiments, the rules stated in the above embodiment are (pre)configured by a network node and sent to the UE and the transmitter UE of the PSSCH. In some other examples, the rules are set by the transmitter UE of the PSSCH and sent to the receiver UE via a sidelink signaling. In some other examples, the rules are set by both a network node and the transmitter UE of the PSSCH.

### Embodiments for Solution 2

According to this embodiment, a UE selects a sequence for transmission of a sequence-based PSFCH in response to a PSSCH by:
Selecting a base sequence for the PSFCH based on an identity of the transmitter UE of the PSSCH according to a rule.
Applying a phase rotation to the base sequence wherein the phase rotation is based on an identity of the UE according to a rule.

In some embodiments, if both PSFCH-ACK and PSFCH-NACK are required, disjoints resource blocks are selected for the PSFCH-ACK and the PSFCH-NACK according to a rule. In one example the resource blocks are consecutive resource blocks.

In some embodiments, the identity of the UE is the physical layer identity of the UE.

In some embodiments, the identity of the transmitter UE of the PSSCH is the physical layer ID of the transmitter UE of the PSSCH, and the ID is indicated in the PSCCH scheduling the PSSCH.

In some embodiments, the rules stated in the above embodiments are (pre)configured by a network node and sent to the UE and the transmitter UE of the PSSCH. In some other examples, the rules are set by the transmitter UE of the PSSCH and sent to the receiver UE via a sidelink signaling. In some other examples, the rules are set by both a network node and the transmitter UE of the PSSCH.

### Embodiments for Solution 3

According to this embodiment, a UE selects/generates a sequence-based PSFCH in response to a PSSCH by:
Selecting a base sequence for the PSFCH based on a combination of an identity indicated by the control information of the PSSCH and the distance from the UE to the transmitter UE of the PSSCH. The selection is according to a rule.
Applying a phase rotation to the base sequence wherein the phase rotation is based on an identity of the UE according to a rule.

In some embodiments, the identity indicated by the control information of the PSSCH (which is used to generate or select the PSFCH sequence) is the physical layer ID of the TX UE of the PSSCH, and the ID is sent in the PSCCH scheduling the PSSCH.

In some embodiments, the identity of the UE is the physical layer identity of the UE.

In some embodiments, the rules stated in the above embodiments are (pre)configured by a network node and sent to the UE and the transmitter UE of the PSSCH. In some other examples, the rules are set by the transmitter UE of the PSSCH and sent to the receiver UE via a sidelink signaling. In some other examples, the rules are set by both a network node and the transmitter UE of the PSSCH.

### Embodiments for Solution 4

According to this embodiment, a UE selects/generates a sequence-based PSFCH to transmit multiple HARQ feedbacks which are in response to multiple PSSCHs by
Determining the set of the TX UEs for which the feedbacks are targeting (i.e., the transmitter UEs of the PSSCHs),
In response to determining that there is only one TX UE in the set, combining the feedbacks in one single PSFCH,
Sending the PSFCH to the determined TX UE.

In some embodiments, combining the feedbacks in one PSFCH is achieved by applying a phase rotation to a base sequence. The feedback bits determine the phase rotation according to certain rule. In one example the rule is (pre)configured by a network node.

In some embodiments, a subchannel among the subchannels in which the PSSCHs are transmitted is selected for the PSFCH according to certain rule. For example, the subchannel with lowest index is selected. In some example a network node (pre)configures the rule.

In some embodiments, in response to determining that there are multiple TX UEs in the set, selecting only one feedback and sending it to the corresponding UE in a PSFCH. In one example, the selected feedback is associated with a data packet with highest priority.

### Embodiments for Solution 5

According to this embodiment, a UE prioritizes using the same subchannel as the subchannel of the associated PSSCH for the transmission of the PSFCH.

In some embodiments, if the PSSCH is transmitted using multiple subchannels, the corresponding PSFCH is transmitted using the subchannel with the lowest index among the multiple subchannels.

### Embodiments for Solution 6

According to this embodiment, a UE prioritizes one PSFCH-related operation (i.e., transmission or reception of HARQ feedback) over another PSFCH-related operation based on the nature of the relevant HARQ feedback information (i.e., whether the feedbacks are ACK or NACK) and whether the related communication is unicast or groupcast.

In some embodiments, in a groupcast the UE prioritizes transmitting a NACK over transmitting an ACK.

In some embodiments, in a unicast the UE prioritizes receiving an ACK over transmitting a NACK.

In some embodiments, in a unicast the UE prioritizes transmitting an ACK over transmitting a NACK.

### Embodiments for Solution 7

This part describes a set of methods to solve the half-duplex issue and the simultaneous transmission issue described above.

Consider a scenario of two unicast transmissions: (i) UE1 to UE2 at t1; and (ii) UE3 to UE1 at t2. Also, assume that an explicit or implicit indication is included in PSCCH and/or PSSCH, which notifies the receiver UE(s) that HARQ feedback is expected.

In one embodiment, a UE selects resource for its own data transmission based on the future PSFCH transmissions where the UE is involved, i.e., the UE is either the transmitter or the receiver of the PSFCH transmissions.

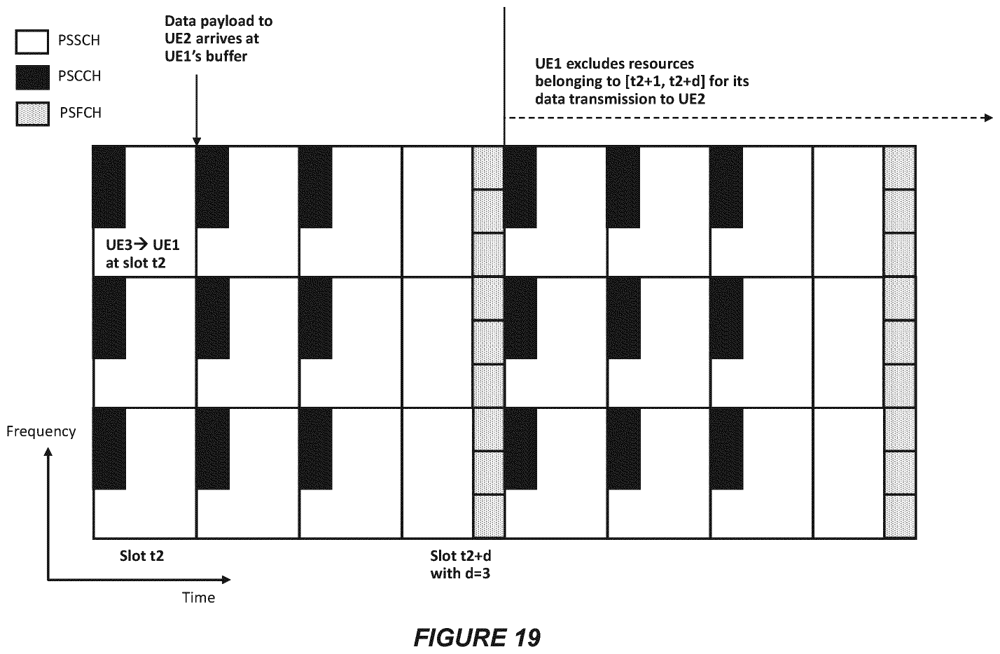

In one alternative where t1>t2, UE1 first receives data from UE3 before sending data to UE2. In this case, UE1 is aware that it needs to send PSFCH to UE3 at time t2+d, where d depends on the time location of the PSFCH resource pool. Hence, when UE1 selects resources for its data transmission to UE2, it will exclude the resources belonging to the current period of PSFCH resource pool. In one example, the resource exclusion is realized by introducing a resource selection window whose starting point is later than t2+d. This solution is illustrated in FIG. 19, where UE1 first receives data from UE3 before sending data to UE2. In this example, the resources for PSFCH are available every 4 slots (i.e., N=4).

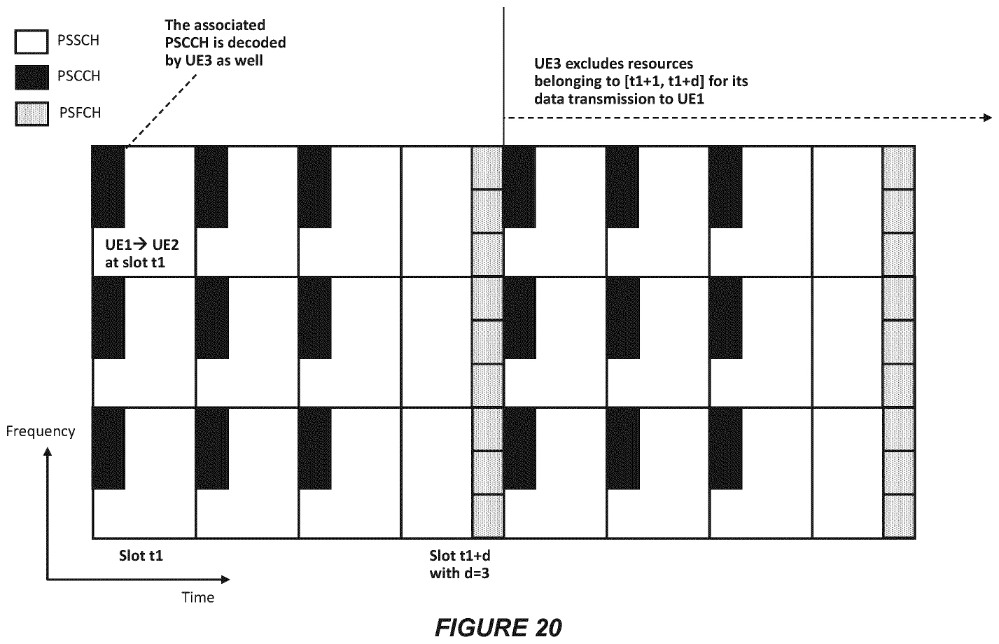

In another alternative where t1<t2, UE1 first sends data to UE2 before receiving data from UE3. In this case, UE3 can be aware that UE1 is expecting a HARQ feedback in the nearest PSFCH resource. Note that this is because, as described above, a UE (e.g., UE1) includes an indication in PSCCH to indicate its expectation of HARQ feedback. In this way, when UE3 selects resources for its data transmission to UE1, it will exclude the resources belonging to the current period of PSFCH resource pool. In one example, the resource exclusion is realized by introducing a resource selection window whose starting point is later than t1+d. This solution is illustrated in FIG. 20, where UE1 first sends data to UE2 before receiving data to UE3. Note that UE3 can decode the data transmission from UE1 to UE2 and uses that knowledge in selecting resources for UE3's data transmission to UE1. In this example, the resources for PSFCH are available every 4 slots (i.e., N=4).

The above description has only focused on HARQ feedback carried by PSFCH. However, embodiments herein can still be applied when other information is contained in PSFCH as well. Embodiments are mainly described from the perspective SL unicast. However, embodiments herein can be extended to SL groupcast as well.

Embodiments are described for the SL mode where UE autonomously select transmission, e.g., NR SL mode-2. However, embodiments can also be applied to the SL mode where NW assign data transmission or PSFCH resource to UEs, e.g., NR SL mode-1.

In some embodiments, HARQ feedback is to be enabled and disabled based on (pre-)configuration. In some embodiments, HARQ enabling/disabling takes congestion control and V2X service requirements into account, and is part of general QoS framework.

Furthermore, an indication to receiver UE in some embodiments is included in sidelink control information (SCI) if HARQ feedback is requested or not. For instance, a flag indicating the need of HARQ feedback if turned on. In some embodiments, then, SCI carries a field indicating the presence of the corresponding HARQ feedback i.e. ACK or NACK based on PSSCH decoding outcome.

In some embodiments, TX-RX distance-based HARQ feedback is supported for at least groupcast option 1, where a UE only transmits HARQ feedback if TX-RX distance is smaller or equal to the communication range requirement. Also, to support this functionality, the TX-RX distance is estimated by RX UE based on its own location and TX UE's location. Then, the next questions are how to define location and how to notify RX UE about TX UE's location.

First, geographical coordinate is a good way to define location since 1) it can represent location information more accurately; 2) it can be used for both NW's in-coverage and out-of-coverage scenarios. However, a full GPS coordinate usually has a size of a few tens of bits, which may be too large overhead if carried in SCI. Hence, PC5-RRC message in some embodiments is used to convey a geographical coordinate with a relatively large size. On the other hand, since the transmission of PC5-RRC messages can be quite infrequently, relying on PC5-RRC only may not give enough updated location information. Therefore, some embodiments combine PC5-RRC with lower layer information carried in SCI, where SCI can contain a relative movement compared to the location sent in the latest PC5-RRC message. Moreover, each UE may store a mapping between other UE's L1 source IDs and their respective locations. In this way, after decoding SCI which contains TX UE's L1 source ID, the RX UE will know how to correctly connect the previously stored location information to the TX UE and then calculate TX-RX distance. In some embodiments, then, that geographical coordinate is used to represent location information. TX UE's location can be sent jointly via PC5-RRC and SCI. A RX UE stores a mapping between Tx UEs' L1 source IDs and their respective locations.

Although sending TX UE's location jointly via PC5-RRC and SCI can reduce the overhead, it may still be a burden for some scenarios. To resolve this issue, both RSRP based and distance based HARQ feedback may be supported and can be (pre-)configured. Also, it may happen that a network (pre-)configures a UE to use both RSRP and distance and in this case, a UE is only allowed to skip HARQ feedback transmission when both criteria are not met. For sidelink groupcast, it is proposed that both distance and RSRP based HARQ feedback criteria are supported and can be (pre-)configured.

Consider PSFCH resource allocation according to some embodiments. In some embodiments, K is determined based on UE capability, which is aligned with the consideration in Uu. For the DMRS configuration with additional DMRS occasions in a slot (which is more relevant for V2X scenario), the minimum UE processing time of DL reception in NR Uu is given in the following table.

TABLE 1
Minimum Processing Time for NR Uu (PDSCH
Mapping Type A, Feedback on PUCCH)

| | |
|---|---|
| Device | Subcarrier spacing |

| capability | 15 kHz | 30 kHz | | 60 kHz | 120 kHz |
|---|---|---|---|---|---|
| Baseline | 0.92 ms | 0.46 | ms | 0.36 ms | 0.21 ms |
| Aggressive | 0.85 ms | 0.4 | ms | | |

By taking into account the minimum processing time of baseline UE capability and the possible slot structure of PSFCH (e.g., 1 or 2 PSFCH symbols, one GP symbol after PSFCH, and one AGC symbol before PSFCH), K may be at least 2 irrespective of the subcarrier spacing in some embodiments. Some embodiments, then, support at least K=2 for all SCS. FFS K=1 for 15 kHz and 30 kHz.

Additionally, an implicit mechanism is to be used to determine frequency and/or code domain resource of PSFCH in response to PSSCH, within a configured resource pool. Consider now the implicit PSFCH resource allocation mechanisms for unicast and groupcast respectively.

For sidelink unicast, the RB used for PSFCH may be confined within the subchannel used by the associated PSSCH. Also, it is more beneficial to send ACK(s) and NACK(s) on different RBs. Furthermore, to differentiate PSFCH transmissions in response to different PSSCHs occurring in the same time-frequency resources, the selected PSFCH resource may depend on the TX UE's source ID. The ID can be used to select a base sequence for HARQ feedback. Hence, the implicit mechanism for unicast can be given by the following formula: PSFCH resource of unicast (RB, code)=function (PSSCH subchannel, TX UE's L1 source ID, decoding outcome).

The following is proposed for sidelink unicast, PSFCH resource (RB, code)=function (PSSCH subchannel, TX UE's L1 source ID, decoding outcome).
a. The used RB is confined within the subchannel of the associated PSSCH transmission.
b. ACK and NACK are transmitted using different RBs within the subchannel.
c. The used code is selected by TX UE's L1 source ID.

For sidelink groupcast, the considerations are similar. However, since each RX UE may use a separate PSFCH for HARQ ACK/NACK for option 2, each RX UE needs in a group needs to be distinguished. For a TX UE, it doesn't need to know the ID of each RX UE since it doesn't need to understand exactly which RX UE has or has not received the packet. On the other hand, what matters is to let the TX UE be aware whether all the RX UEs have received the packet successfully. If not, the TX UE can perform another retransmission. For this purpose, for one groupcast, the base sequence used for all the PSFCH resources of RX UEs should be the same, which depends on TX UE's L1 source ID. On top of it, each RX UE can select a cyclic shift applied to the base sequence, where the cyclic shift depends on the RX UE's source ID. In this way, without additional signalling between TX and RX UEs, the TX UE can still know which base sequence the PSFCH resources have used and then perform blind detection over all the possible cyclic shifts of the base sequence. The allowed values of cyclic shifts can be configured in advance. Therefore, the implicit mechanism for groupcast can be given by the following formula: PSFCH resource of groupcast (RB, code)=function (PSSCH subchannel, TX UE's L1 source ID, decoding outcome, RX UE's source ID).

Accordingly, for sidelink groupcast, PSFCH resource (RB, code)=function (PSSCH subchannel, TX UE's L1 source ID, decoding outcome, RX UE's source ID).
d. The used RB is confined within the subchannel of the associated PSSCH transmission.
e. ACK and NACK transmissions are FDM multiplexed.
f. The base sequence of the used codes is selected by TX UE's L1 source ID.
g. The cyclic shift applied to the base sequence is selected by RX UE's ID

Consider now how groupcast receivers share PSFCH for both option 1 and option 2. It can be beneficial that a subset of them share one PSFCH resource for ACK/NACK. Selection of the subset depends on their locations, i.e., their respective Tx-Rx distances. For example, in FIG. 18, the UEs belonging to Range d1 (UE1 and UE2) send NACK feedback (FB) on PSFCH resource 1; the UEs belong to Range d2 (UE3, UE4, and UE5) send NACK feedback (FB) on PSFCH resource 2; the UEs belong to Range d3 (UE6 and UE7) send NACK feedback (FB) on PSFCH resource 3. In this way, a subset of Rx UEs share one PSFCH resource, where the subset selection depends on Rx UEs' locations.

Observe then that, for some scenarios, it can be beneficial to divide groupcast Rx UEs into subsets depending on their distances to the Tx UE. The different subsets use different PSFCH resources for sending HARQ feedbacks.

As analyzed above, it is useful to support a subset of receiver UEs sharing a PSFCH for both option 1 and option 2. It can be that, either only the subset of UEs send HARQ feedback, or more than one subset of UEs transmit HARQ feedback on different PSFCH resources. In particular, for option 2, when there are larger number of receivers in a group, the consumed PSFCH resources will be too much if each receiver UE uses a separate PSFCH for HARQ ACK/NACK. It will degrade the performance of the whole system. Note that the PSFCH resources need to be shared by all the UEs in the system. Therefore, in this case, ACK and NACK feedbacks should be limited to a set of specific resources. For instance, for one SL groupcast connection, one PSFCH resource is used for all the ACK transmissions and another PSFCH resource is used for all the NACK transmissions. Furthermore, a subset of receiving UEs sharing a PSFCH, e.g., depending on their distances with the transmitter UE as illustrated in FIG. 18, is beneficial for outer-loop link adaptation as well. In this way, the transmitter UE has a better view about how far its transmission can reach.

For groupcast option 1, it is proposed to support that a subset of the receiver UEs share a PSFCH. For groupcast option 2, it is proposed to support that all or a subset of receiver UEs share a PSFCH for ACK transmission and another PSFCH for NACK transmission.

In addition, mixing option 1 and option 2 based on congestion is unnecessary and would require a separate RRC configuration for each UE belonging to a same group. In case of congested network, limitation on PSFCH resources can be avoided by sharing same PSFCH resource among a subset of UEs belonging to the group. It is proposed in some embodiments that NR SL does not support a mixture of option 1 and option 2 for groupcast transmissions.

Moreover, having all UEs in the group request HARQ retransmission in case of failed decoded degrades the performance from system perspective. Therefore, restrictions on the retransmissions themselves may be considered for both HARQ options. One such criteria is to pre-define thresholds for HARQ ACK or NACK. For instance, a UE retransmits the packet only if total number of HARQ NACKs received are above the threshold or a UE does not retransmit the packet if certain number of HARQ ACKs are received. It is proposed in some embodiments that restrictions on the retransmissions of TB are applied for both HARQ options for the purpose of congestion control.

Consider now how to handle the three cases of PSFCH transmission and reception, including PSFCH TX/RX overlap, PSFCH TX to multiple UEs, and PSFCH TX with multiple HARQ feedback to the same UE. A simple and unified solution is prioritization. More specifically, a RX UE can prioritize between PSFCH TX and RX, prioritize among PSFCH TX to multiple UEs, or prioritize among PSFCH TX with multiple HARQ feedbacks to the same UE based on (pre-)configured rules which depend on e.g., QoS requirements of the corresponding services. Alternatively, the prioritization can also be up to UE implementation.

Prioritization is applied to handle the three possible cases of PSFCH transmission and reception, including PSFCH TX/RX overlap, PSFCH TX to multiple UEs, and PSFCH TX with multiple HARQ feedback to the same UE. FFS if the prioritization is based on (pre-)configured rules or up to UE implementation.

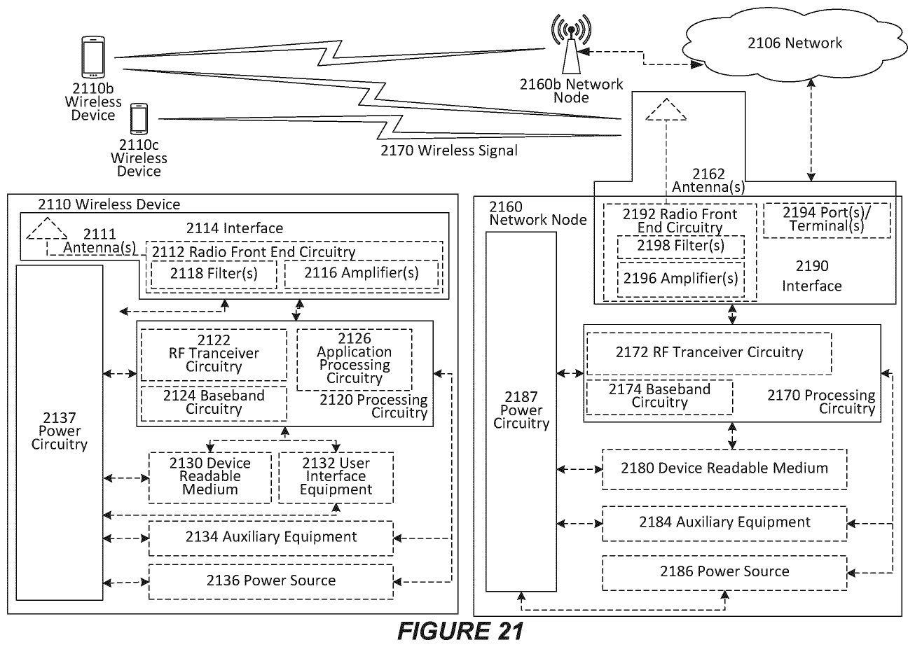

Although the subject matter described herein may be implemented in any appropriate type of system using any suitable components, the embodiments disclosed herein are described in relation to a wireless network, such as the example wireless network illustrated in FIG. 21. For simplicity, the wireless network of FIG. 21 only depicts network 2106, network nodes 2160 and 2160b, and WDs 2110, 2110b, and 2110c. In practice, a wireless network may further include any additional elements suitable to support communication between wireless devices or between a wireless device and another communication device, such as a landline telephone, a service provider, or any other network node or end device. Of the illustrated components, network node 2160 and wireless device (WD) 2110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2160 and WD 2110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 21, network node 2160 includes processing circuitry 2170, device readable medium 2180, interface 2190, auxiliary equipment 2184, power source 2186, power circuitry 2187, and antenna 2162. Although network node 2160 illustrated in the example wireless network of FIG. 21 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2160 are depicted as single boxes located within a larger box, or nested within multiple boxes, in practice, a network node may comprise multiple different physical components that make up a single illustrated component (e.g., device readable medium 2180 may comprise multiple separate hard drives as well as multiple RAM modules).

Similarly, network node 2160 may be composed of multiple physically separate components (e.g., a NodeB component and a RNC component, or a BTS component and a BSC component, etc.), which may each have their own respective components. In certain scenarios in which network node 2160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2160 may be configured to support multiple radio access technologies (RATs). In such embodiments, some components may be duplicated (e.g., separate device readable medium 2180 for the different RATs) and some components may be reused (e.g., the same antenna 2162 may be shared by the RATs). Network node 2160 may also include multiple sets of the various illustrated components for different wireless technologies integrated into network node 2160, such as, for example, GSM, WCDMA, LTE, NR, WiFi, or Bluetooth wireless technologies. These wireless technologies may be integrated into the same or different chip or set of chips and other components within network node 2160.

Processing circuitry 2170 is configured to perform any determining, calculating, or similar operations (e.g., certain obtaining operations) described herein as being provided by a network node. These operations performed by processing circuitry 2170 may include processing information obtained by processing circuitry 2170 by, for example, converting the obtained information into other information, comparing the obtained information or converted information to information stored in the network node, and/or performing one or more operations based on the obtained information or converted information, and as a result of said processing making a determination.

Processing circuitry 2170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2160 components, such as device readable medium 2180, network node 2160 functionality. For example, processing circuitry 2170 may execute instructions stored in device readable medium 2180 or in memory within processing circuitry 2170. Such functionality may include providing any of the various wireless features, functions, or benefits discussed herein. In some embodiments, processing circuitry 2170 may include a system on a chip (SOC).

In some embodiments, processing circuitry 2170 may include one or more of radio frequency (RF) transceiver circuitry 2172 and baseband processing circuitry 2174. In some embodiments, radio frequency (RF) transceiver circuitry 2172 and baseband processing circuitry 2174 may be on separate chips (or sets of chips), boards, or units, such as radio units and digital units. In alternative embodiments, part or all of RF transceiver circuitry 2172 and baseband processing circuitry 2174 may be on the same chip or set of chips, boards, or units

In certain embodiments, some or all of the functionality described herein as being provided by a network node, base station, eNB or other such network device may be performed by processing circuitry 2170 executing instructions stored on device readable medium 2180 or memory within processing circuitry 2170. In alternative embodiments, some or all of the functionality may be provided by processing circuitry 2170 without executing instructions stored on a separate or discrete device readable medium, such as in a hard-wired manner. In any of those embodiments, whether executing instructions stored on a device readable storage medium or not, processing circuitry 2170 can be configured to perform the described functionality. The benefits provided by such functionality are not limited to processing circuitry 2170 alone or to other components of network node 2160, but are enjoyed by network node 2160 as a whole, and/or by end users and the wireless network generally.

Device readable medium 2180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2170. Device readable medium 2180 may store any suitable instructions, data or information, including a computer program, software, an application including one or more of logic, rules, code, tables, etc. and/or other instructions capable of being executed by processing circuitry 2170 and, utilized by network node 2160. Device readable medium 2180 may be used to store any calculations made by processing circuitry 2170 and/or any data received via interface 2190. In some embodiments, processing circuitry 2170 and device readable medium 2180 may be considered to be integrated.

Interface 2190 is used in the wired or wireless communication of signalling and/or data between network node 2160, network 2106, and/or WDs 2110. As illustrated, interface 2190 comprises port(s)/terminal(s) 2194 to send and receive data, for example to and from network 2106 over a wired connection. Interface 2190 also includes radio front end circuitry 2192 that may be coupled to, or in certain embodiments a part of, antenna 2162. Radio front end circuitry 2192 comprises filters 2198 and amplifiers 2196. Radio front end circuitry 2192 may be connected to antenna 2162 and processing circuitry 2170. Radio front end circuitry may be configured to condition signals communicated between antenna 2162 and processing circuitry 2170. Radio front end circuitry 2192 may receive digital data that is to be sent out to other network nodes or WDs via a wireless connection. Radio front end circuitry 2192 may convert the digital data into a radio signal having the appropriate channel and bandwidth parameters using a combination of filters 2198 and/or amplifiers 2196. The radio signal may then be transmitted via antenna 2162. Similarly, when receiving data, antenna 2162 may collect radio signals which are then converted into digital data by radio front end circuitry 2192. The digital data may be passed to processing circuitry 2170. In other embodiments, the interface may comprise different components and/or different combinations of components.

In certain alternative embodiments, network node 2160 may not include separate radio front end circuitry 2192, instead, processing circuitry 2170 may comprise radio front end circuitry and may be connected to antenna 2162 without separate radio front end circuitry 2192. Similarly, in some embodiments, all or some of RF transceiver circuitry 2172 may be considered a part of interface 2190. In still other embodiments, interface 2190 may include one or more ports or terminals 2194, radio front end circuitry 2192, and RF transceiver circuitry 2172, as part of a radio unit (not shown), and interface 2190 may communicate with baseband processing circuitry 2174, which is part of a digital unit (not shown).

Antenna 2162 may include one or more antennas, or antenna arrays, configured to send and/or receive wireless signals. Antenna 2162 may be coupled to radio front end circuitry 2190 and may be any type of antenna capable of transmitting and receiving data and/or signals wirelessly. In some embodiments, antenna 2162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 2162 may be separate from network node 2160 and may be connectable to network node 2160 through an interface or port.

Antenna 2162, interface 2190, and/or processing circuitry 2170 may be configured to perform any receiving operations and/or certain obtaining operations described herein as being performed by a network node. Any information, data and/or signals may be received from a wireless device, another network node and/or any other network equipment. Similarly, antenna 2162, interface 2190, and/or processing circuitry 2170 may be configured to perform any transmitting operations described herein as being performed by a network node. Any information, data and/or signals may be transmitted to a wireless device, another network node and/or any other network equipment.

Power circuitry 2187 may comprise, or be coupled to, power management circuitry and is configured to supply the components of network node 2160 with power for performing the functionality described herein. Power circuitry 2187 may receive power from power source 2186. Power source 2186 and/or power circuitry 2187 may be configured to provide power to the various components of network node 2160 in a form suitable for the respective components (e.g., at a voltage and current level needed for each respective component). Power source 2186 may either be included in, or external to, power circuitry 2187 and/or network node 2160. For example, network node 2160 may be connectable to an external power source (e.g., an electricity outlet) via an input circuitry or interface such as an electrical cable, whereby the external power source supplies power to power circuitry 2187. As a further example, power source 2186 may comprise a source of power in the form of a battery or battery pack which is connected to, or integrated in, power circuitry 2187. The battery may provide backup power should the external power source fail. Other types of power sources, such as photovoltaic devices, may also be used.

Alternative embodiments of network node 2160 may include additional components beyond those shown in FIG. 21 that may be responsible for providing certain aspects of the network node's functionality, including any of the functionality described herein and/or any functionality necessary to support the subject matter described herein. For example, network node 2160 may include user interface equipment to allow input of information into network node 2160 and to allow output of information from network node 2160. This may allow a user to perform diagnostic, maintenance, repair, and other administrative functions for network node 2160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 2110 includes antenna 2111, interface 2114, processing circuitry 2120, device readable medium 2130, user interface equipment 2132, auxiliary equipment 2134, power source 2136 and power circuitry 2137. WD 2110 may include multiple sets of one or more of the illustrated components for different wireless technologies supported by WD 2110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 2110.

Antenna 2111 may include one or more antennas or antenna arrays, configured to send and/or receive wireless signals, and is connected to interface 2114. In certain alternative embodiments, antenna 2111 may be separate from WD 2110 and be connectable to WD 2110 through an interface or port. Antenna 2111, interface 2114, and/or processing circuitry 2120 may be configured to perform any receiving or transmitting operations described herein as being performed by a WD. Any information, data and/or signals may be received from a network node and/or another WD. In some embodiments, radio front end circuitry and/or antenna 2111 may be considered an interface.

As illustrated, interface 2114 comprises radio front end circuitry 2112 and antenna 2111. Radio front end circuitry 2112 comprise one or more filters 2118 and amplifiers 2116. Radio front end circuitry 2114 is connected to antenna 2111 and processing circuitry 2120, and is configured to condition signals communicated between antenna 2111 and processing circuitry 2120. Radio front end circuitry 2112 may be coupled to or a part of antenna 2111. In some embodiments, WD 2110 may not include separate radio front end circuitry 2112; rather, processing circuitry 2120 may comprise radio front end circuitry and may be connected to antenna 2111. Similarly, in some embodiments, some or all of RF transceiver circuitry 2122 may be considered a part of interface 2114. Radio front end circuitry 2112 may receive digital data that is to be sent out to other network nodes or WDs via a wireless connection. Radio front end circuitry 2112 may convert the digital data into a radio signal having the appropriate channel and bandwidth parameters using a combination of filters 2118 and/or amplifiers 2116. The radio signal may then be transmitted via antenna 2111. Similarly, when receiving data, antenna 2111 may collect radio signals which are then converted into digital data by radio front end circuitry 2112. The digital data may be passed to processing circuitry 2120. In other embodiments, the interface may comprise different components and/or different combinations of components.

Processing circuitry 2120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2110 components, such as device readable medium 2130, WD 2110 functionality. Such functionality may include providing any of the various wireless features or benefits discussed herein. For example, processing circuitry 2120 may execute instructions stored in device readable medium 2130 or in memory within processing circuitry 2120 to provide the functionality disclosed herein.

As illustrated, processing circuitry 2120 includes one or more of RF transceiver circuitry 2122, baseband processing circuitry 2124, and application processing circuitry 2126. In other embodiments, the processing circuitry may comprise different components and/or different combinations of components. In certain embodiments processing circuitry 2120 of WD 2110 may comprise a SOC. In some embodiments, RF transceiver circuitry 2122, baseband processing circuitry 2124, and application processing circuitry 2126 may be on separate chips or sets of chips. In alternative embodiments, part or all of baseband processing circuitry 2124 and application processing circuitry 2126 may be combined into one chip or set of chips, and RF transceiver circuitry 2122 may be on a separate chip or set of chips. In still alternative embodiments, part or all of RF transceiver circuitry 2122 and baseband processing circuitry 2124 may be on the same chip or set of chips, and application processing circuitry 2126 may be on a separate chip or set of chips. In yet other alternative embodiments, part or all of RF transceiver circuitry 2122, baseband processing circuitry 2124, and application processing circuitry 2126 may be combined in the same chip or set of chips. In some embodiments, RF transceiver circuitry 2122 may be a part of interface 2114. RF transceiver circuitry 2122 may condition RF signals for processing circuitry 2120.

In certain embodiments, some or all of the functionality described herein as being performed by a WD may be provided by processing circuitry 2120 executing instructions stored on device readable medium 2130, which in certain embodiments may be a computer-readable storage medium. In alternative embodiments, some or all of the functionality may be provided by processing circuitry 2120 without executing instructions stored on a separate or discrete device readable storage medium, such as in a hard-wired manner. In any of those particular embodiments, whether executing instructions stored on a device readable storage medium or not, processing circuitry 2120 can be configured to perform the described functionality. The benefits provided by such functionality are not limited to processing circuitry 2120 alone or to other components of WD 2110, but are enjoyed by WD 2110 as a whole, and/or by end users and the wireless network generally.

Processing circuitry 2120 may be configured to perform any determining, calculating, or similar operations (e.g., certain obtaining operations) described herein as being performed by a WD. These operations, as performed by processing circuitry 2120, may include processing information obtained by processing circuitry 2120 by, for example, converting the obtained information into other information, comparing the obtained information or converted information to information stored by WD 2110, and/or performing one or more operations based on the obtained information or converted information, and as a result of said processing making a determination.

Device readable medium 2130 may be operable to store a computer program, software, an application including one or more of logic, rules, code, tables, etc. and/or other instructions capable of being executed by processing circuitry 2120. Device readable medium 2130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2120. In some embodiments, processing circuitry 2120 and device readable medium 2130 may be considered to be integrated.

User interface equipment 2132 may provide components that allow for a human user to interact with WD 2110. Such interaction may be of many forms, such as visual, audial, tactile, etc. User interface equipment 2132 may be operable to produce output to the user and to allow the user to provide input to WD 2110. The type of interaction may vary depending on the type of user interface equipment 2132 installed in WD 2110. For example, if WD 2110 is a smart phone, the interaction may be via a touch screen; if WD 2110 is a smart meter, the interaction may be through a screen that provides usage (e.g., the number of gallons used) or a speaker that provides an audible alert (e.g., if smoke is detected). User interface equipment 2132 may include input interfaces, devices and circuits, and output interfaces, devices and circuits. User interface equipment 2132 is configured to allow input of information into WD 2110, and is connected to processing circuitry 2120 to allow processing circuitry 2120 to process the input information. User interface equipment 2132 may include, for example, a microphone, a proximity or other sensor, keys/buttons, a touch display, one or more cameras, a USB port, or other input circuitry. User interface equipment 2132 is also configured to allow output of information from WD 2110, and to allow processing circuitry 2120 to output information from WD 2110. User interface equipment 2132 may include, for example, a speaker, a display, vibrating circuitry, a USB port, a headphone interface, or other output circuitry. Using one or more input and output interfaces, devices, and circuits, of user interface equipment 2132, WD 2110 may communicate with end users and/or the wireless network, and allow them to benefit from the functionality described herein.

Auxiliary equipment 2134 is operable to provide more specific functionality which may not be generally performed by WDs. This may comprise specialized sensors for doing measurements for various purposes, interfaces for additional types of communication such as wired communications etc. The inclusion and type of components of auxiliary equipment 2134 may vary depending on the embodiment and/or scenario.

Power source 2136 may, in some embodiments, be in the form of a battery or battery pack. Other types of power sources, such as an external power source (e.g., an electricity outlet), photovoltaic devices or power cells, may also be used. WD 2110 may further comprise power circuitry 2137 for delivering power from power source 2136 to the various parts of WD 2110 which need power from power source 2136 to carry out any functionality described or indicated herein. Power circuitry 2137 may in certain embodiments comprise power management circuitry. Power circuitry 2137 may additionally or alternatively be operable to receive power from an external power source; in which case WD 2110 may be connectable to the external power source (such as an electricity outlet) via input circuitry or an interface such as an electrical power cable. Power circuitry 2137 may also in certain embodiments be operable to deliver power from an external power source to power source 2136. This may be, for example, for the charging of power source 2136. Power circuitry 2137 may perform any formatting, converting, or other modification to the power from power source 2136 to make the power suitable for the respective components of WD 2110 to which power is supplied.

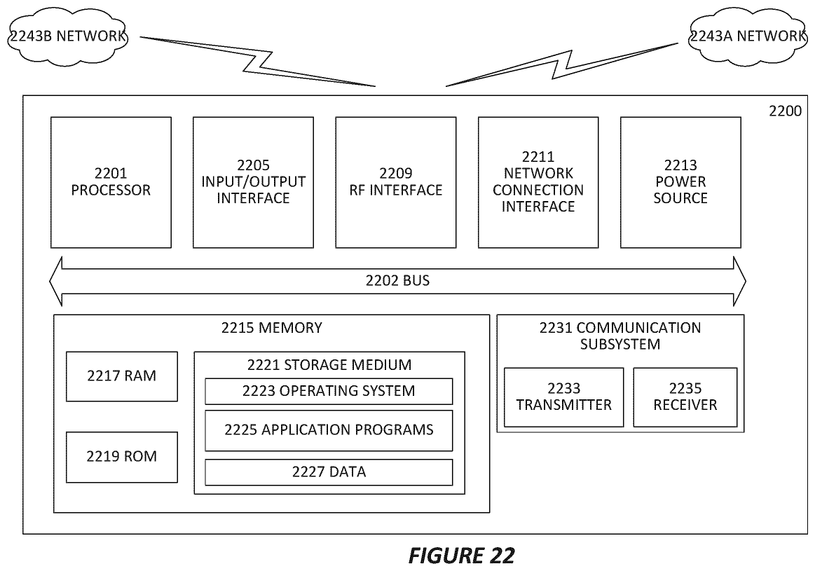

FIG. 22 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 22200 may be any UE identified by the 3^{rd} Generation Partnership Project (3GPP), including a NB-IoT UE, a machine type communication (MTC) UE, and/or an enhanced MTC (eMTC) UE. UE 2200, as illustrated in FIG. 22, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 22 is a UE, the components discussed herein are equally applicable to a WD, and vice-versa.

In FIG. 22, UE 2200 includes processing circuitry 2201 that is operatively coupled to input/output interface 2205, radio frequency (RF) interface 2209, network connection interface 2211, memory 2215 including random access memory (RAM) 2217, read-only memory (ROM) 2219, and storage medium 2221 or the like, communication subsystem 2231, power source 2233, and/or any other component, or any combination thereof. Storage medium 2221 includes operating system 2223, application program 2225, and data 2227. In other embodiments, storage medium 2221 may include other similar types of information. Certain UEs may utilize all of the components shown in FIG. 22, or only a subset of the components. The level of integration between the components may vary from one UE to another UE. Further, certain UEs may contain multiple instances of a component, such as multiple processors, memories, transceivers, transmitters, receivers, etc.

In FIG. 22, processing circuitry 2201 may be configured to process computer instructions and data. Processing circuitry 2201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2201 may include two central processing units (CPUs). Data may be information in a form suitable for use by a computer.

In the depicted embodiment, input/output interface 2205 may be configured to provide a communication interface to an input device, output device, or input and output device. UE 2200 may be configured to use an output device via input/output interface 2205. An output device may use the same type of interface port as an input device. For example, a USB port may be used to provide input to and output from UE 2200. The output device may be a speaker, a sound card, a video card, a display, a monitor, a printer, an actuator, an emitter, a smartcard, another output device, or any combination thereof. UE 2200 may be configured to use an input device via input/output interface 2205 to allow a user to capture information into UE 2200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 22, RF interface 2209 may be configured to provide a communication interface to RF components such as a transmitter, a receiver, and an antenna. Network connection interface 2211 may be configured to provide a communication interface to network 2243a. Network 2243a may encompass wired and/or wireless networks such as a local-area network (LAN), a wide-area network (WAN), a computer network, a wireless network, a telecommunications network, another like network or any combination thereof. For example, network 2243a may comprise a Wi-Fi network. Network connection interface 2211 may be configured to include a receiver and a transmitter interface used to communicate with one or more other devices over a communication network according to one or more communication protocols, such as Ethernet, TCP/IP, SONET, ATM, or the like. Network connection interface 2211 may implement receiver and transmitter functionality appropriate to the communication network links (e.g., optical, electrical, and the like). The transmitter and receiver functions may share circuit components, software or firmware, or alternatively may be implemented separately.

RAM 2217 may be configured to interface via bus 2202 to processing circuitry 2201 to provide storage or caching of data or computer instructions during the execution of software programs such as the operating system, application programs, and device drivers. ROM 2219 may be configured to provide computer instructions or data to processing circuitry 2201. For example, ROM 2219 may be configured to store invariant low-level system code or data for basic system functions such as basic input and output (I/O), startup, or reception of keystrokes from a keyboard that are stored in a non-volatile memory. Storage medium 2221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2221 may be configured to include operating system 2223, application program 2225 such as a web browser application, a widget or gadget engine or another application, and data file 2227. Storage medium 2221 may store, for use by UE 2200, any of a variety of various operating systems or combinations of operating systems.

Storage medium 2221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2221 may allow UE 2200 to access computer-executable instructions, application programs or the like, stored on transitory or non-transitory memory media, to off-load data, or to upload data. An article of manufacture, such as one utilizing a communication system may be tangibly embodied in storage medium 2221, which may comprise a device readable medium.

In FIG. 22, processing circuitry 2201 may be configured to communicate with network 2243b using communication subsystem 2231. Network 2243a and network 2243b may be the same network or networks or different network or networks. Communication subsystem 2231 may be configured to include one or more transceivers used to communicate with network 2243b. For example, communication subsystem 2231 may be configured to include one or more transceivers used to communicate with one or more remote transceivers of another device capable of wireless communication such as another WD, UE, or base station of a radio access network (RAN) according to one or more communication protocols, such as IEEE 802.22, CDMA, WCDMA, GSM, LTE, UTRAN, WiMax, or the like. Each transceiver may include transmitter 2233 and/or receiver 2235 to implement transmitter or receiver functionality, respectively, appropriate to the RAN links (e.g., frequency allocations and the like). Further, transmitter 2233 and receiver 2235 of each transceiver may share circuit components, software or firmware, or alternatively may be implemented separately.

In the illustrated embodiment, the communication functions of communication subsystem 2231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2231 may include cellular communication, Wi-Fi communication, Bluetooth communication, and GPS communication. Network 2243b may encompass wired and/or wireless networks such as a local-area network (LAN), a wide-area network (WAN), a computer network, a wireless network, a telecommunications network, another like network or any combination thereof. For example, network 2243b may be a cellular network, a Wi-Fi network, and/or a near-field network. Power source 2213 may be configured to provide alternating current (AC) or direct current (DC) power to components of UE 2200.

The features, benefits and/or functions described herein may be implemented in one of the components of UE 2200 or partitioned across multiple components of UE 2200. Further, the features, benefits, and/or functions described herein may be implemented in any combination of hardware, software or firmware. In one example, communication subsystem 2231 may be configured to include any of the components described herein. Further, processing circuitry 2201 may be configured to communicate with any of such components over bus 2202. In another example, any of such components may be represented by program instructions stored in memory that when executed by processing circuitry 2201 perform the corresponding functions described herein. In another example, the functionality of any of such components may be partitioned between processing circuitry 2201 and communication subsystem 2231. In another example, the non-computationally intensive functions of any of such components may be implemented in software or firmware and the computationally intensive functions may be implemented in hardware.

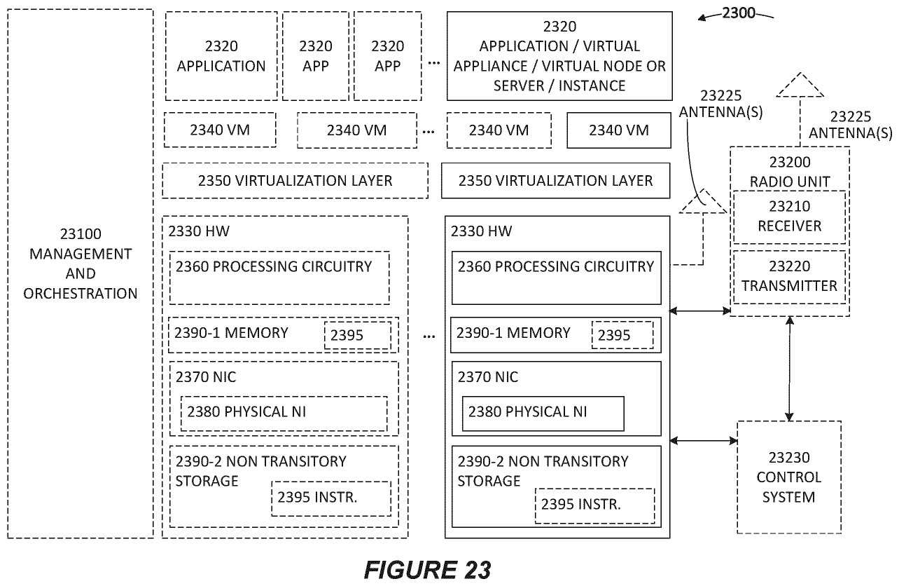

FIG. 23 is a schematic block diagram illustrating a virtualization environment 2300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2300 hosted by one or more of hardware nodes 2330. Further, in embodiments in which the virtual node is not a radio access node or does not require radio connectivity (e.g., a core network node), then the network node may be entirely virtualized.

The functions may be implemented by one or more applications 2320 (which may alternatively be called software instances, virtual appliances, network functions, virtual nodes, virtual network functions, etc.) operative to implement some of the features, functions, and/or benefits of some of the embodiments disclosed herein. Applications 2320 are run in virtualization environment 2300 which provides hardware 2330 comprising processing circuitry 2360 and memory 2390. Memory 2390 contains instructions 2395 executable by processing circuitry 2360 whereby application 2320 is operative to provide one or more of the features, benefits, and/or functions disclosed herein.

Virtualization environment 2300, comprises general-purpose or special-purpose network hardware devices 2330 comprising a set of one or more processors or processing circuitry 2360, which may be commercial off-the-shelf (COTS) processors, dedicated Application Specific Integrated Circuits (ASICs), or any other type of processing circuitry including digital or analog hardware components or special purpose processors. Each hardware device may comprise memory 2390-1 which may be non-persistent memory for temporarily storing instructions 2395 or software executed by processing circuitry 2360. Each hardware device may comprise one or more network interface controllers (NICs) 2370, also known as network interface cards, which include physical network interface 2380. Each hardware device may also include non-transitory, persistent, machine-readable storage media 2390-2 having stored therein software 2395 and/or instructions executable by processing circuitry 2360. Software 2395 may include any type of software including software for instantiating one or more virtualization layers 2350 (also referred to as hypervisors), software to execute virtual machines 2340 as well as software allowing it to execute functions, features and/or benefits described in relation with some embodiments described herein.

Virtual machines 2340, comprise virtual processing, virtual memory, virtual networking or interface and virtual storage, and may be run by a corresponding virtualization layer 2350 or hypervisor. Different embodiments of the instance of virtual appliance 2320 may be implemented on one or more of virtual machines 2340, and the implementations may be made in different ways.

During operation, processing circuitry 2360 executes software 2395 to instantiate the hypervisor or virtualization layer 2350, which may sometimes be referred to as a virtual machine monitor (VMM). Virtualization layer 2350 may present a virtual operating platform that appears like networking hardware to virtual machine 2340.

As shown in FIG. 23, hardware 2330 may be a standalone network node with generic or specific components. Hardware 2330 may comprise antenna 23225 and may implement some functions via virtualization. Alternatively, hardware 2330 may be part of a larger cluster of hardware (e.g. such as in a data center or customer premise equipment (CPE)) where many hardware nodes work together and are managed via management and orchestration (MANO) 23100, which, among others, oversees lifecycle management of applications 2320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2340 may be a software implementation of a physical machine that runs programs as if they were executing on a physical, non-virtualized machine. Each of virtual machines 2340, and that part of hardware 2330 that executes that virtual machine, be it hardware dedicated to that virtual machine and/or hardware shared by that virtual machine with others of the virtual machines 2340, forms a separate virtual network elements (VNE).

Still in the context of NFV, Virtual Network Function (VNF) is responsible for handling specific network functions that run in one or more virtual machines 2340 on top of hardware networking infrastructure 2330 and corresponds to application 2320 in FIG. 23.

In some embodiments, one or more radio units 23200 that each include one or more transmitters 23220 and one or more receivers 23210 may be coupled to one or more antennas 23225. Radio units 23200 may communicate directly with hardware nodes 2330 via one or more appropriate network interfaces and may be used in combination with the virtual components to provide a virtual node with radio capabilities, such as a radio access node or a base station.

In some embodiments, some signalling can be effected with the use of control system 23230 which may alternatively be used for communication between the hardware nodes 2330 and radio units 23200.

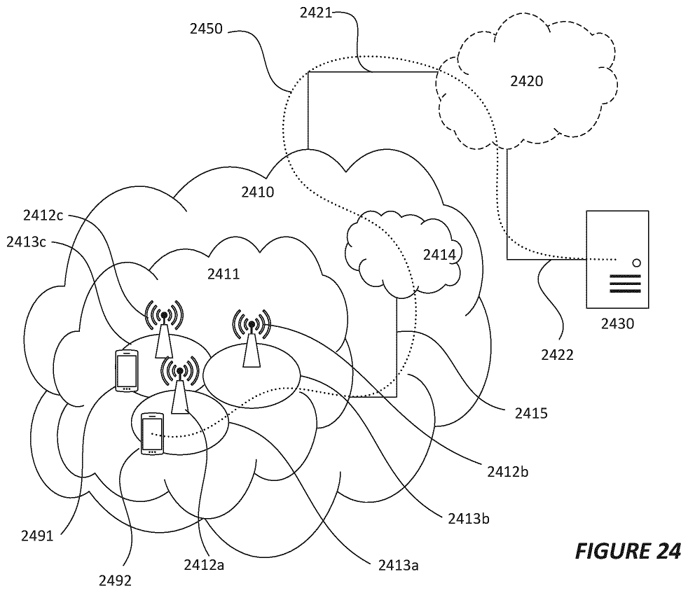

FIG. 24 illustrates a telecommunication network connected via an intermediate network to a host computer in accordance with some embodiments. In particular, with reference to FIG. 24, in accordance with an embodiment, a communication system includes telecommunication network 2410, such as a 3GPP-type cellular network, which comprises access network 2411, such as a radio access network, and core network 2414. Access network 2411 comprises a plurality of base stations 2412a, 2412b, 2412c, such as NBs, eNBs, gNBs or other types of wireless access points, each defining a corresponding coverage area 2413a, 2413b, 2413c. Each base station 2412a, 2412b, 2412c is connectable to core network 2414 over a wired or wireless connection 2415. A first UE 2491 located in coverage area 2413c is configured to wirelessly connect to, or be paged by, the corresponding base station 2412c. A second UE 2492 in coverage area 2413a is wirelessly connectable to the corresponding base station 2412a. While a plurality of UEs 2491, 2492 are illustrated in this example, the disclosed embodiments are equally applicable to a situation where a sole UE is in the coverage area or where a sole UE is connecting to the corresponding base station 2412.

Telecommunication network 2410 is itself connected to host computer 2430, which may be embodied in the hardware and/or software of a standalone server, a cloud-implemented server, a distributed server or as processing resources in a server farm. Host computer 2430 may be under the ownership or control of a service provider, or may be operated by the service provider or on behalf of the service provider. Connections 2421 and 2422 between telecommunication network 2410 and host computer 2430 may extend directly from core network 2414 to host computer 2430 or may go via an optional intermediate network 2420. Intermediate network 2420 may be one of, or a combination of more than one of, a public, private or hosted network; intermediate network 2420, if any, may be a backbone network or the Internet; in particular, intermediate network 2420 may comprise two or more sub-networks (not shown).

The communication system of FIG. 24 as a whole enables connectivity between the connected UEs 2491, 2492 and host computer 2430. The connectivity may be described as an over-the-top (OTT) connection 2450. Host computer 2430 and the connected UEs 2491, 2492 are configured to communicate data and/or signaling via OTT connection 2450, using access network 2411, core network 2414, any intermediate network 2420 and possible further infrastructure (not shown) as intermediaries. OTT connection 2450 may be transparent in the sense that the participating communication devices through which OTT connection 2450 passes are unaware of routing of uplink and downlink communications. For example, base station 2412 may not or need not be informed about the past routing of an incoming downlink communication with data originating from host computer 2430 to be forwarded (e.g., handed over) to a connected UE 2491. Similarly, base station 2412 need not be aware of the future routing of an outgoing uplink communication originating from the UE 2491 towards the host computer 2430.

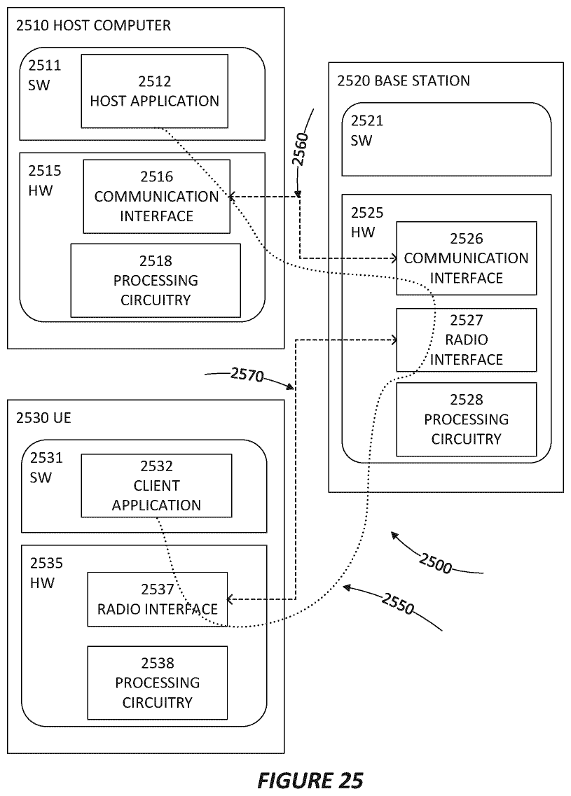

Example implementations, in accordance with an embodiment, of the UE, base station and host computer discussed in the preceding paragraphs will now be described with reference to FIG. 25. FIG. 25 illustrates host computer communicating via a base station with a user equipment over a partially wireless connection in accordance with some embodiments In communication system 2500, host computer 2510 comprises hardware 2515 including communication interface 2516 configured to set up and maintain a wired or wireless connection with an interface of a different communication device of communication system 2500. Host computer 2510 further comprises processing circuitry 2518, which may have storage and/or processing capabilities. In particular, processing circuitry 2518 may comprise one or more programmable processors, application-specific integrated circuits, field programmable gate arrays or combinations of these (not shown) adapted to execute instructions. Host computer 2510 further comprises software 2511, which is stored in or accessible by host computer 2510 and executable by processing circuitry 2518.

Software 2511 includes host application 2512. Host application 2512 may be operable to provide a service to a remote user, such as UE 2530 connecting via OTT connection 2550 terminating at UE 2530 and host computer 2510. In providing the service to the remote user, host application 2512 may provide user data which is transmitted using OTT connection 2550.

Communication system 2500 further includes base station 2520 provided in a telecommunication system and comprising hardware 2525 enabling it to communicate with host computer 2510 and with UE 2530. Hardware 2525 may include communication interface 2526 for setting up and maintaining a wired or wireless connection with an interface of a different communication device of communication system 2500, as well as radio interface 2527 for setting up and maintaining at least wireless connection 2570 with UE 2530 located in a coverage area (not shown in FIG. 25) served by base station 2520. Communication interface 2526 may be configured to facilitate connection 2560 to host computer 2510. Connection 2560 may be direct or it may pass through a core network (not shown in FIG. 25) of the telecommunication system and/or through one or more intermediate networks outside the telecommunication system. In the embodiment shown, hardware 2525 of base station 2520 further includes processing circuitry 2528, which may comprise one or more programmable processors, application-specific integrated circuits, field programmable gate arrays or combinations of these (not shown) adapted to execute instructions. Base station 2520 further has software 2521 stored internally or accessible via an external connection.

Communication system 2500 further includes UE 2530 already referred to. Its hardware 2535 may include radio interface 2537 configured to set up and maintain wireless connection 2570 with a base station serving a coverage area in which UE 2530 is currently located. Hardware 2535 of UE 2530 further includes processing circuitry 2538, which may comprise one or more programmable processors, application-specific integrated circuits, field programmable gate arrays or combinations of these (not shown) adapted to execute instructions. UE 2530 further comprises software 2531, which is stored in or accessible by UE 2530 and executable by processing circuitry 2538. Software 2531 includes client application 2532. Client application 2532 may be operable to provide a service to a human or non-human user via UE 2530, with the support of host computer 2510. In host computer 2510, an executing host application 2512 may communicate with the executing client application 2532 via OTT connection 2550 terminating at UE 2530 and host computer 2510. In providing the service to the user, client application 2532 may receive request data from host application 2512 and provide user data in response to the request data. OTT connection 2550 may transfer both the request data and the user data. Client application 2532 may interact with the user to generate the user data that it provides.

It is noted that host computer 2510, base station 2520 and UE 2530 illustrated in FIG. 25 may be similar or identical to host computer 2430, one of base stations 2412a, 2412b, 2412c and one of UEs 2491, 2492 of FIG. 24, respectively. This is to say, the inner workings of these entities may be as shown in FIG. 25 and independently, the surrounding network topology may be that of FIG. 24.

In FIG. 25, OTT connection 2550 has been drawn abstractly to illustrate the communication between host computer 2510 and UE 2530 via base station 2520, without explicit reference to any intermediary devices and the precise routing of messages via these devices. Network infrastructure may determine the routing, which it may be configured to hide from UE 2530 or from the service provider operating host computer 2510, or both. While OTT connection 2550 is active, the network infrastructure may further take decisions by which it dynamically changes the routing (e.g., on the basis of load balancing consideration or reconfiguration of the network).

Wireless connection 2570 between UE 2530 and base station 2520 is in accordance with the teachings of the embodiments described throughout this disclosure. One or more of the various embodiments improve the performance of OTT services provided to UE 2530 using OTT connection 2550, in which wireless connection 2570 forms the last segment.

A measurement procedure may be provided for the purpose of monitoring data rate, latency and other factors on which the one or more embodiments improve. There may further be an optional network functionality for reconfiguring OTT connection 2550 between host computer 2510 and UE 2530, in response to variations in the measurement results. The measurement procedure and/or the network functionality for reconfiguring OTT connection 2550 may be implemented in software 2511 and hardware 2515 of host computer 2510 or in software 2531 and hardware 2535 of UE 2530, or both. In embodiments, sensors (not shown) may be deployed in or in association with communication devices through which OTT connection 2550 passes; the sensors may participate in the measurement procedure by supplying values of the monitored quantities exemplified above, or supplying values of other physical quantities from which software 2511, 2531 may compute or estimate the monitored quantities. The reconfiguring of OTT connection 2550 may include message format, retransmission settings, preferred routing etc.; the reconfiguring need not affect base station 2520, and it may be unknown or imperceptible to base station 2520. Such procedures and functionalities may be known and practiced in the art. In certain embodiments, measurements may involve proprietary UE signaling facilitating host computer 2510's measurements of throughput, propagation times, latency and the like. The measurements may be implemented in that software 2511 and 2531 causes messages to be transmitted, in particular empty or ‘dummy’ messages, using OTT connection 2550 while it monitors propagation times, errors etc.

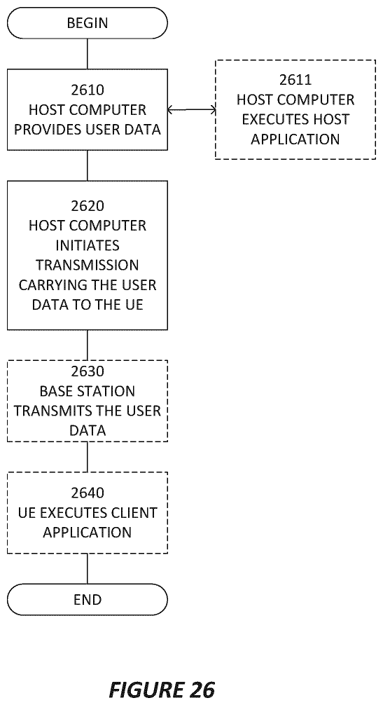

FIG. 26 is a flowchart illustrating a method implemented in a communication system, in accordance with one embodiment. The communication system includes a host computer, a base station and a UE which may be those described with reference to FIGS. 24 and 25. For simplicity of the present disclosure, only drawing references to FIG. 26 will be included in this section. In step 2610, the host computer provides user data. In substep 2611 (which may be optional) of step 2610, the host computer provides the user data by executing a host application. In step 2620, the host computer initiates a transmission carrying the user data to the UE. In step 2630 (which may be optional), the base station transmits to the UE the user data which was carried in the transmission that the host computer initiated, in accordance with the teachings of the embodiments described throughout this disclosure. In step 2640 (which may also be optional), the UE executes a client application associated with the host application executed by the host computer.

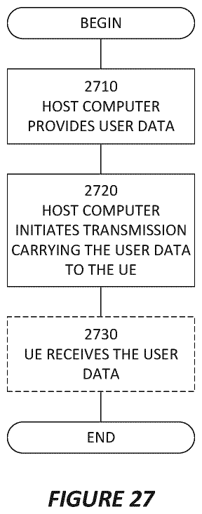

FIG. 27 is a flowchart illustrating a method implemented in a communication system, in accordance with one embodiment. The communication system includes a host computer, a base station and a UE which may be those described with reference to FIGS. 24 and 25. For simplicity of the present disclosure, only drawing references to FIG. 27 will be included in this section. In step 2710 of the method, the host computer provides user data. In an optional substep (not shown) the host computer provides the user data by executing a host application. In step 2720, the host computer initiates a transmission carrying the user data to the UE. The transmission may pass via the base station, in accordance with the teachings of the embodiments described throughout this disclosure. In step 2730 (which may be optional), the UE receives the user data carried in the transmission.

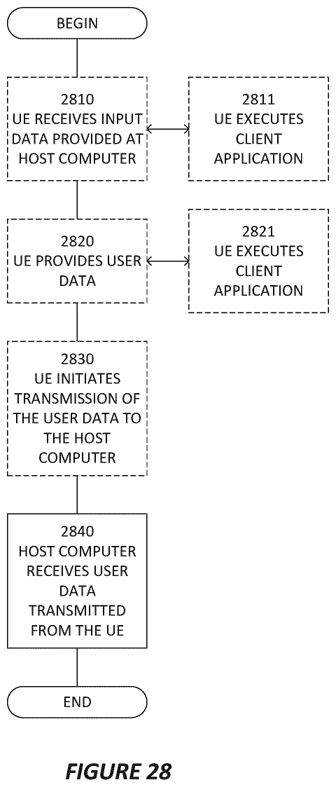

FIG. 28 is a flowchart illustrating a method implemented in a communication system, in accordance with one embodiment. The communication system includes a host computer, a base station and a UE which may be those described with reference to FIGS. 24 and 25. For simplicity of the present disclosure, only drawing references to FIG. 28 will be included in this section. In step 2810 (which may be optional), the UE receives input data provided by the host computer. Additionally or alternatively, in step 2820, the UE provides user data. In substep 2821 (which may be optional) of step 2820, the UE provides the user data by executing a client application. In substep 2811 (which may be optional) of step 2810, the UE executes a client application which provides the user data in reaction to the received input data provided by the host computer. In providing the user data, the executed client application may further consider user input received from the user. Regardless of the specific manner in which the user data was provided, the UE initiates, in substep 2830 (which may be optional), transmission of the user data to the host computer. In step 2840 of the method, the host computer receives the user data transmitted from the UE, in accordance with the teachings of the embodiments described throughout this disclosure.

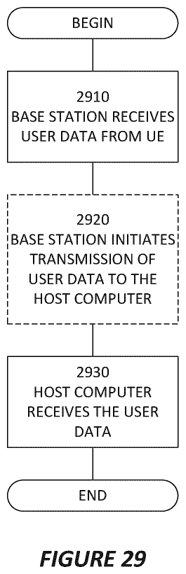

FIG. 29 is a flowchart illustrating a method implemented in a communication system, in accordance with one embodiment. The communication system includes a host computer, a base station and a UE which may be those described with reference to FIGS. 24 and 25. For simplicity of the present disclosure, only drawing references to FIG. 29 will be included in this section. In step 2910 (which may be optional), in accordance with the teachings of the embodiments described throughout this disclosure, the base station receives user data from the UE. In step 2920 (which may be optional), the base station initiates transmission of the received user data to the host computer. In step 2930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Example embodiments of the techniques and apparatus described herein include, but are not limited to, the following enumerated examples:

### GROUP A EMBODIMENTS

A1. A method performed by a wireless device, the method comprising:
receiving a data transmission from a peer wireless device on a sidelink between the wireless device and the peer wireless device; and
transmitting, to the peer wireless device, a sequence that is based on an identity of the peer wireless device, wherein transmission of the sequence conveys acknowledgement feedback for the data transmission.
   A2. The method of embodiment A1, further comprising generating or selecting the sequence based on the identity of the peer wireless device.
   A3. The method of any of embodiments A1-A2, wherein the sequence is also based on an identity of the wireless device.
   A4. The method of any of embodiments A1-A3, wherein the sequence is a version of a base sequence, wherein the base sequence is based on the identity of the peer wireless device, wherein the version of the base sequence is a phase-rotated version of the base sequence or a cyclically-shifted version of the base sequence.
   A5. The method of embodiment A4, wherein a phase rotation of the base sequence, or a cyclic shift of the base sequence, is based on an identity of the wireless device.
   A6. The method of any of embodiments A4-A5, further comprising generating the sequence by:
generating or selecting the base sequence based on the identity of the peer wireless device;
determining, based on an identity of the wireless device, a phase rotation or cyclic shift to apply to the base sequence; and
applying the determined phase rotation or cyclic shift to the base sequence.
   A7. The method any of embodiments A1-A6, wherein the sequence is also based on a distance between the wireless device and the peer wireless device.
   A8. The method of embodiment A7, wherein the sequence is a version of a base sequence, wherein the base sequence is based on the identity of the peer wireless device and the distance between the wireless device and the peer wireless device, wherein the version of the base sequence is a phase-rotated version of the base sequence or a cyclically-shifted version of the base sequence.
   A9. The method of embodiment A8, wherein different ranges of distances are associated with different base sequences, and wherein the method further comprises:
determining within which of the different ranges of distances the distance between the wireless device and the peer wireless device is included; and
determining, from among the different base sequences, the base sequence that is associated with the determined range of distances.
   A10. The method of any of embodiments A1-A9, further comprising selecting a resource block in which to transmit the sequence and wherein transmitting the sequence comprises transmitting the sequence in the selected resource block.
   A11. The method of embodiment A10, wherein selecting the resource block is based on an identity of the wireless device.
   A12. The method of any of embodiments A10-A11, wherein selecting the resource block is based on the acknowledgement feedback to be conveyed, such that transmission of the sequence on a certain resource block conveys the acknowledgement feedback.
   A13. The method of embodiment A12, wherein selecting the resource block comprises selecting the resource block from between two candidate resource blocks respectively associated with positive acknowledgement and negative acknowledgement, depending on whether the acknowledgement feedback to be conveyed positively or negatively acknowledges the data transmission.
   A14. The method of any of embodiments A10-A13, wherein selecting the resource block comprises selecting the resource block among multiple resource blocks across multiple subchannels, wherein each subchannel includes one or more resource blocks.
   A15. The method of any of embodiments A10-A14, wherein the sequence is transmitted on a certain subchannel, and wherein selecting the resource block comprises selecting the resource block among multiple resource blocks in the certain subchannel.
   A16. The method of any of embodiments A1-A15, wherein transmitting the sequence comprises transmitting the sequence on the same subchannel as the subchannel on which the data transmission is received.
   A17. The method of any of embodiments A1-A16, wherein the data transmission is a vehicle-to-everything, V2X, data transmission on a sidelink between the wireless device and the peer wireless device.
   A18. The method of any of embodiments A1-A17, wherein the sequence is transmitted on a physical sidelink feedback channel, PSFCH.
   A19. A method performed by a wireless device, the method comprising:
receiving a data transmission from a peer wireless device on a sidelink between the wireless device and the peer wireless device; and
transmitting, to the peer wireless device, a sequence that is based on a distance between the wireless device and the peer wireless device, wherein transmission of the sequence conveys acknowledgement feedback for the data transmission.
   A20. The method of embodiment A19, wherein the sequence is a version of a base sequence, wherein the base sequence is based on the distance between the wireless device and the peer wireless device, wherein the version of the base sequence is a phase-rotated version of the base sequence or a cyclically-shifted version of the base sequence.
   A21. The method of embodiment A20, wherein different ranges of distances are associated with different base sequences, and wherein the method further comprises:
determining within which of the different ranges of distances the distance between the wireless device and the peer wireless device is included; and
determining, from among the different base sequences, the base sequence that is associated with the determined range of distances.
   A22. The method of any of embodiments A19-A21, wherein the sequence is also based on an identity of the peer wireless device.
   A23. The method of any of embodiments A19-A22, further comprising selecting a resource block in which to transmit the sequence and wherein transmitting the sequence comprises transmitting the sequence in the selected resource block.
   A24. The method of embodiment A23, wherein selecting the resource block is based on an identity of the wireless device.
   A25. The method of any of embodiments A23-A24, wherein selecting the resource block is based on the acknowledgement feedback to be conveyed, such that transmission of the sequence on a certain resource block conveys the acknowledgement feedback.
   A26. The method of embodiment A25, wherein selecting the resource block comprises selecting the resource block from between two candidate resource blocks respectively associated with positive acknowledgement and negative acknowledgement, depending on whether the acknowledgement feedback to be conveyed positively or negatively acknowledges the data transmission.
   A27. The method of any of embodiments A23-A26, wherein the sequence is transmitted on a certain subchannel, and wherein selecting the resource block comprises selecting the resource block among multiple resource blocks in the certain subchannel.
   A28. The method of any of embodiments A19-A27, wherein transmitting the sequence comprises transmitting the sequence on the same subchannel as the subchannel on which the data transmission is received.
   A29. The method of any of embodiments A19-A29, wherein the data transmission is a vehicle-to-everything, V2X, data transmission on a sidelink between the wireless device and the peer wireless device.
   A30. The method of any of embodiments A19-A29, wherein the sequence is transmitted on a physical sidelink feedback channel, PSFCH.
   A31. A method performed by a wireless device, the method comprising:
receiving a data transmission from a peer wireless device on a sidelink between the wireless device and the peer wireless device;
selecting a resource block in which to transmit a sequence for conveying acknowledgement feedback for the data transmission, wherein the resource block is selected based on one or more of:
an identity of the wireless device; or the acknowledgement feedback to be conveyed; and
transmitting the sequence to the peer wireless device on the selected resource block.
   A32. The method of embodiment A31, wherein selecting the resource block is based on the acknowledgement feedback to be conveyed, such that transmission of the sequence on a certain resource block conveys the acknowledgement feedback.
   A33. The method of embodiment A32, wherein selecting the resource block comprises selecting the resource block from between two candidate resource blocks respectively associated with positive acknowledgement and negative acknowledgement, depending on whether the acknowledgement feedback to be conveyed positively or negatively acknowledges the data transmission.
   A34. The method of any of embodiments A31-A33, wherein the resource block is selected based on the identity of the wireless device.
   A35. The method of any of embodiments A31-A34, wherein the resource block is selected based on whether the acknowledgement feedback to be conveyed indicates positive acknowledgement of the data transmission or negative acknowledgement of the data transmission.
   A36. The method of any of embodiments A31-A35, wherein selecting the resource block comprises selecting the resource block among multiple resource blocks across multiple subchannels, wherein each subchannel includes one or more resource blocks.
   A37. The method of any of embodiments A31-A36, wherein the sequence is transmitted on a certain subchannel, and wherein selecting the resource block comprises selecting the resource block among multiple resource blocks in the certain subchannel.
   A38. The method of any of embodiments A31-A37, wherein transmitting the sequence comprises transmitting the sequence on the same subchannel as the subchannel on which the data transmission is received.
   A39. The method of any of embodiments A31-A38, wherein the sequence is based on an identity of the peer wireless device.
   A40. The method of any of embodiments A31-A39, wherein the data transmission is a vehicle-to-everything, V2X, data transmission on a sidelink between the wireless device and the peer wireless device.
   A41. The method of any of embodiments A31-A40, wherein the sequence is transmitted on a physical sidelink feedback channel, PSFCH.
   A42. A method performed by a wireless device, the method comprising:
receiving a data transmission from a peer wireless device on a subchannel of a sidelink between the wireless device and the peer wireless device; and
transmitting a sequence to the peer wireless device on the same subchannel as the subchannel on which the data transmission was received, wherein transmission of the sequence conveys acknowledgement feedback for the data transmission.
   A43. The method of embodiment A42, wherein the data transmission is a vehicle-to-everything, V2X, data transmission on a sidelink between the wireless device and the peer wireless device.
   A44. The method of any of embodiments A42-A43, wherein the sequence is transmitted on a physical sidelink feedback channel, PSFCH.
   A45. A method performed by a wireless device, the method comprising:
receiving data transmissions on one or more sidelinks, wherein acknowledgement feedback for each of the data transmissions is to be conveyed in the same feedback reporting time interval;
identifying, for each of the data transmissions, a peer wireless device to which the acknowledgement feedback for that data transmission is to be conveyed; and
for a peer wireless device that, according to said identifying, is to be conveyed the acknowledgement feedback for multiple ones of the data transmissions, transmitting, to the peer wireless device and in the same feedback reporting time interval, a sequence that conveys the acknowledgement feedback for the multiple ones of the data transmissions, with the acknowledgement feedback for different data transmissions being differentiated in a code domain.
   A46. The method of embodiment A45, wherein the transmitted sequence comprises a phase rotated version of a base sequence, and wherein different phase rotations of the base sequence convey different combinations of the acknowledgement feedback for the multiple ones of the data transmissions.
   A47. The method of any of embodiments A45-A46, wherein the data transmissions are received on different respective sidelink data channels.
   A48. The method of any of embodiments A46-A47, wherein the data transmissions are received in two or more different subchannels, and wherein the sequence is transmitted in a selected one of the two or more different subchannels.
   A49. The method of embodiment A48, wherein the selected subchannel is a subchannel with a lowest index or a subchannel on which a data transmission with a highest priority was received.
   A50. The method of any of embodiments A45-A49, wherein the sequence is capable of differentiating in the code domain acknowledgement feedback for a maximum number of data transmissions, and wherein the method further comprises:
determining that the sequence is incapable of differentiating in the code domain acknowledgement feedback to be conveyed to the peer wireless device for one or more data transmissions in excess of said maximum number; and
discarding or refraining from conveying to the peer wireless device acknowledgement feedback for the one or more data transmissions in excess of said maximum number.
   A51. The method of embodiment A50, wherein said discarding or refraining is based on the one or more data transmissions in excess of said maximum number being received later in time than the multiple ones of the data transmissions for which the sequence conveys acknowledgment feedback and/or the one or more data transmissions in excess of said maximum number conveying lower priority data than the multiple ones of the data transmissions for which the sequence conveys acknowledgment feedback.
   A52. A method performed by a wireless device, the method comprising:
determining, from among multiple acknowledgement feedback operations to be performed in the same time slot, a subset of the multiple acknowledgement feedback operations to perform in the time slot, based on one or more rules that assign respective priorities to the multiple acknowledgment feedback operations; and
performing, in the time slot, the acknowledgment feedback operations included in the determined subset.
   A53. The method of embodiment A52, wherein the multiple acknowledgement feedback operations include transmitting positive acknowledgment of a first data transmission and transmitting negative acknowledgement of a second data transmission.
   A54. The method of embodiment A53, wherein the first data transmission is a groupcast transmission, and wherein the determined subset includes transmitting the negative acknowledgment and excludes transmitting the positive acknowledgement.
   A55. The method of embodiment A53, wherein the first and second data transmissions are each a unicast transmission, and wherein the determined subset includes transmitting the positive acknowledgment and excludes transmitting the negative acknowledgement.
   A56. The method of embodiment A52, wherein the multiple acknowledgement feedback operations include transmitting acknowledgement feedback and receiving acknowledgement feedback, and wherein the determined subset includes receiving acknowledgement feedback and excludes transmitting acknowledgement feedback.
   A57. The method of any of embodiments A52-A56, wherein the one or more rules assign respective priorities to the multiple acknowledgment feedback operations based on one or more of:
whether an acknowledgement feedback operation is for transmitting or receiving acknowledgement feedback;
whether acknowledgement feedback for an acknowledgment feedback operation is a positive acknowledgement or a negative acknowledgement; or
whether a data transmission for which an acknowledgment feedback operation is to be performed is a unicast transmission or a groupcast transmission.
   A58. A method performed by a wireless device, the method comprising:
scheduling when to perform a data transmission from the wireless device to a peer wireless device on a sidelink between the wireless device and the peer wireless device, based on when acknowledgement feedback is to be transmitted or received for another data transmission; and
performing the data transmission according to said scheduling.
   A59. The method of embodiment A58, wherein said scheduling is based on when the wireless device is to transmit or receive the acknowledgement feedback for the another data transmission.
   A60. The method of any of embodiments A58-A59, wherein said scheduling is based on when the peer wireless device is to transmit or receive the acknowledgement feedback for the another data transmission.
   A61. The method of embodiment A60, further comprising determining when the peer wireless device is to transmit or receive acknowledgement feedback for another data transmission based on decoding the another data transmission.
   A62. The method of any of embodiments A58-A61, wherein a pool of radio resources for acknowledgement feedback recurs periodically, and wherein said scheduling comprises scheduling the data transmission to be performed so that acknowledgement feedback for that data transmission is to be received by the wireless device in a period of the pool that is different than a period of the pool in which acknowledgement feedback for the another data transmission is to be transmitted or received.
   A63. The method of any of embodiments A58-A62, wherein said scheduling comprises delaying performance of the data transmission until after expiration a period of a pool of radio resources for acknowledgement feedback, wherein the acknowledgement feedback for the another data transmission is to be transmitted or received in that period.
   A64. A method performed by a wireless device, the method comprising:
receiving control signaling indicating one or more rules according to which the wireless device is to:
   generate a sequence for conveying acknowledgement feedback for a data transmission received from a peer wireless device on a sidelink between the wireless device and the peer wireless device;
   select a resource block in which to transmit the sequence; and/or
   select a subchannel on which to transmit the sequence.
      A65. The method of embodiment A64, wherein the control signaling indicates one or more rules according to which the wireless device is to generate the sequence.
      A66. The method of embodiment A65, wherein the one or more rules indicate the sequence is to be generated based on an identity of the peer wireless device.
      A67. The method of embodiment A66, wherein the sequence is a version of a base sequence, wherein according to the one or more rules the base sequence is based on the identity of the peer wireless device, wherein the version of the base sequence is a phase-rotated version of the base sequence or a cyclically-shifted version of the base sequence.
      A68. The method of embodiment A67, wherein a phase rotation of the base sequence, or a cyclic shift of the base sequence, is based on an identity of the wireless device.
      A69. The method of any of embodiments A64-A68, wherein the one or more rules indicate the sequence is to be generated based on a distance between the wireless device and the peer wireless device.
      A70. The method of embodiment A69, wherein the one or more rules indicate different ranges of distances are associated with different sequences.
      A71. The method of any of embodiments A69-A70, wherein the sequence is a version of a base sequence, wherein the base sequence is based on an identity of the peer wireless device and the distance between the wireless device and the peer wireless device, wherein the version of the base sequence is a phase-rotated version of the base sequence or a cyclically-shifted version of the base sequence, wherein the one or more rules indicate different ranges of distances are associated with different base sequences.
      A72. The method of any of embodiments A64-A71, wherein the control signaling indicates one or more rules according to which the wireless device is to select a resource block in which to transmit the sequence.
      A73. The method of embodiment A72, wherein the one or more rules indicate the resource block is to be selected based on an identity of the wireless device.
      A74. The method of any of embodiments A72-A73, wherein the one or more rules indicate the resource block is to be selected based on whether the acknowledgement feedback to be conveyed indicates positive acknowledgement of the data transmission or negative acknowledgement of the data transmission.
      A75. The method of embodiment A74, wherein the one or more rules indicate different resource blocks are to be used for conveying positive acknowledgement and negative acknowledgement.
      A76. The method of any of embodiments A64-A75, wherein the control signaling indicates one or more rules according to which the wireless device is to select a subchannel on which to transmit the sequence.
      A77. The method of embodiment A76, wherein the one or more rules indicate prioritization rules for prioritizing on which of multiple subchannels the sequence is to be transmitted.
      A78. The method of any of embodiments A74-A77, wherein the data transmission is a vehicle-to-everything, V2X, data transmission on a sidelink between the wireless device and the peer wireless device.
      A79. The method of any of embodiments A64-A78, wherein the sequence is transmitted on a physical sidelink feedback channel, PSFCH.
      A80. The method of any of embodiments A64-A79, further comprising applying the one or more rules according to the control signalling to generate the sequence, select the resource block, and/or select the subchannel.
      A81. The method any of embodiments A64-A80, further comprising transmitting the sequence for conveying the acknowledgment feedback according to the one or more rules.
      A82. The method of any of embodiments A64-A81, wherein the control signalling is received from the peer wireless device.
      A83. The method of any of embodiments A64-A81, wherein the control signalling is received from a radio network node.
      AA. The method of any of the previous embodiments, further comprising:
providing user data; and
forwarding the user data to a host computer via the transmission to a base station.

### GROUP X EMBODIMENTS

X1. A method performed by a peer wireless device, the method comprising:
transmitting a data transmission from the peer wireless device to a wireless device on a sidelink between the wireless device and the peer wireless device; and
receiving, from the wireless device, a transmission of a sequence that is based on an identity of the peer wireless device, wherein the transmission of the sequence conveys acknowledgement feedback for the data transmission.
   X2. The method of embodiment X1, wherein the sequence is also based on an identity of the wireless device.
   X3. The method of any of embodiments X1-X2, wherein the sequence is a version of a base sequence, wherein the base sequence is based on the identity of the peer wireless device, wherein the version of the base sequence is a phase-rotated version of the base sequence or a cyclically-shifted version of the base sequence.
   X4. The method of embodiment X3, wherein a phase rotation of the base sequence, or a cyclic shift of the base sequence, is based on an identity of the wireless device.
   X5. The method any of embodiments X1-X4, wherein the sequence is also based on a distance between the wireless device and the peer wireless device.
   X6. The method of embodiment X5, wherein the sequence is a version of a base sequence, wherein the base sequence is based on the identity of the peer wireless device and the distance between the wireless device and the peer wireless device, wherein the version of the base sequence is a phase-rotated version of the base sequence or a cyclically-shifted version of the base sequence.
   X7. The method of embodiment X6, wherein different ranges of distances are associated with different base sequences, and wherein the method further comprises:
determining within which of the different ranges of distances the distance between the wireless device and the peer wireless device is included; and
determining, from among the different base sequences, the base sequence that is associated with the determined range of distances.
   X8. The method of any of embodiments X1-X7, wherein the sequence is received on a resource block associated with an identity of the wireless device.
   X9. The method of embodiment X8, further comprising receiving the transmission of the sequence on a certain resource block, and determining the acknowledgement feedback conveyed based on which resource block the transmission of the sequence is received on.
   X10. The method of embodiment X9, wherein different candidate resource blocks are respectively associated with positive acknowledgment and negative acknowledgement, and wherein the method further comprises determining whether the transmission of the sequence conveys acknowledgment feedback which positively acknowledges the data transmission or negatively acknowledges the data transmission depending on which of the candidate resource blocks the sequence is received on.
   X11. The method of any of embodiments X1-X10, wherein receiving the sequence comprises receiving the sequence on the same subchannel as the subchannel on which the data transmission is transmitted.
   X12. The method of any of embodiments X1-X11, wherein the data transmission is a vehicle-to-everything, V2X, data transmission on a sidelink between the wireless device and the peer wireless device.
   X13. The method of any of embodiments X1-X12, wherein the sequence is received on a physical sidelink feedback channel, PSFCH.
   X14. A method performed by a peer wireless device, the method comprising:
transmitting a data transmission from the peer wireless device to a wireless device on a sidelink between the wireless device and the peer wireless device; and
receiving, from the wireless device, a sequence that is based on a distance between the wireless device and the peer wireless device, wherein transmission of the sequence conveys acknowledgement feedback for the data transmission.
   X15. The method of embodiment X14, wherein the sequence is a version of a base sequence, wherein the base sequence is based on the distance between the wireless device and the peer wireless device, wherein the version of the base sequence is a phase-rotated version of the base sequence or a cyclically-shifted version of the base sequence.
   X16. The method of embodiment X15, wherein different ranges of distances are associated with different base sequences, and wherein the method further comprises:
determining within which of the different ranges of distances the distance between the wireless device and the peer wireless device is included; and
determining, from among the different base sequences, the base sequence that is associated with the determined range of distances.
   X17. The method of any of embodiments X15-X16, wherein the sequence is also based on an identity of the peer wireless device.
   X18. The method of any of embodiments X15-X17, wherein the sequence is received on a resource block associated with an identity of the wireless device.
   X19. The method of any of embodiments X15-X18, further comprising receiving the transmission of the sequence on a certain resource block, and determining the acknowledgement feedback conveyed based on which resource block the transmission of the sequence is received on.
   X20. The method of embodiment X19, wherein different candidate resource blocks are respectively associated with positive acknowledgment and negative acknowledgement, and wherein the method further comprises determining whether the transmission of the sequence conveys acknowledgment feedback which positively acknowledges the data transmission or negatively acknowledges the data transmission depending on which of the candidate resource blocks the sequence is received on.
   X21. The method of any of embodiments X17-X20, wherein receiving the sequence comprises receiving the sequence on the same subchannel as the subchannel on which the data transmission is transmitted.
   X22. The method of any of embodiments X17-X21, wherein the data transmission is a vehicle-to-everything, V2X, data transmission on a sidelink between the wireless device and the peer wireless device.
   X23. The method of any of embodiments X17-X22, wherein the sequence is received on a physical sidelink feedback channel, PSFCH.
   X24. A method performed by a peer wireless device, the method comprising:
transmitting a data transmission from the peer wireless device to a wireless device on a sidelink between the wireless device and the peer wireless device; and
receiving a transmission of a sequence from the wireless device, wherein the transmission of the sequence conveys acknowledgment feedback for the data transmission, wherein the transmission of the sequence is received on a resource block that depends on one or more of:
   an identity of the wireless device; or
   the acknowledgement feedback.
      X25. The method of embodiment X24, further comprising determining the acknowledgement feedback conveyed based on which resource block the transmission of the sequence is received on.
      X26. The method of embodiment X25, wherein different candidate resource blocks are respectively associated with positive acknowledgment and negative acknowledgement, and wherein the method further comprises determining whether the transmission of the sequence conveys acknowledgment feedback which positively acknowledges the data transmission or negatively acknowledges the data transmission depending on which of the candidate resource blocks the sequence is received on.
      X27. The method of any of embodiments X24-X26, wherein the sequence is received on a resource block that depends on the identity of the wireless device.
      X28. The method of any of embodiments X24-X27, wherein the sequence is received on a resource block that depends on whether the acknowledgement feedback to be conveyed indicates positive acknowledgement of the data transmission or negative acknowledgement of the data transmission.
      X29. The method of any of embodiments X24-X28, further comprising determining whether the acknowledgement feedback conveyed by the sequence indicates positive acknowledgement of the data transmission or negative acknowledgement of the data transmission, based on which resource block the sequence is received.
      X30. The method of any of embodiments X24-X29, wherein receiving the sequence comprises receiving the sequence on the same subchannel as the subchannel on which the data transmission is transmitted.
      X31. The method of any of embodiments X24-X30, wherein the data transmission is a vehicle-to-everything, V2X, data transmission on a sidelink between the wireless device and the peer wireless device.
      X32. The method of any of embodiments X24-X31, wherein the sequence is received on a physical sidelink feedback channel, PSFCH.
      X33. A method performed by a peer wireless device, the method comprising:
transmitting a data transmission from the peer wireless device to a wireless device on a subchannel of a sidelink between the wireless device and the peer wireless device; and
receiving a transmission of a sequence from the wireless device on the same subchannel as the subchannel on which the data transmission was transmitted, wherein the transmission of the sequence conveys acknowledgement feedback for the data transmission.
   X34. The method of embodiment X33, wherein the data transmission is a vehicle-to-everything, V2X, data transmission on a sidelink between the wireless device and the peer wireless device.
   X35. The method of any of embodiments X33-X34, wherein the sequence is received on a physical sidelink feedback channel, PSFCH.
   X36. A method performed by a peer wireless device, the method comprising:
transmitting multiple data transmissions from the peer wireless device to a wireless device on one or more sidelinks between the wireless device and the peer wireless device; and
receiving, from the wireless device, a sequence that conveys acknowledgement feedback for the multiple data transmissions, with acknowledgement feedback for respective ones of the multiple data transmissions being differentiated in a code domain.
   X37. The method of embodiment A36, wherein the received sequence comprises a phase rotated version of a base sequence, and wherein different phase rotations of the base sequence convey different combinations of acknowledgement feedback for the multiple data transmissions.
   X38. The method of any of embodiments X36-X37, wherein the multiple data transmissions are transmitted on different respective sidelink data channels.
   X39. The method of any of embodiments X36-X38, wherein the multiple data transmissions are transmitted in two or more different subchannels, and wherein the sequence is received in a selected one of the two or more different subchannels.
   X40. The method of embodiment X39, wherein the selected subchannel is a subchannel with a lowest index or a subchannel on which a data transmission with a highest priority was transmitted.
   X41. The method of any of embodiments X36-X40, further comprising:
transmitting one or more other data transmissions from the peer wireless device for which acknowledgement feedback is to be received in the same time interval as the acknowledgement feedback for the multiple data transmissions; and
determining that no acknowledgement feedback is to be received for the one or more other data transmissions.
   X42. The method of embodiment X41, wherein said determining is based on the one or more other data transmissions being received later in time than the multiple data transmissions and/or the one or more other data transmissions conveying lower priority data than the multiple data transmissions.
   X43. A method performed by a peer wireless device, the method comprising:
transmitting control signaling indicating one or more rules according to which a wireless device is to:
   generate a sequence for conveying acknowledgement feedback for a data transmission received from the peer wireless device on a sidelink between the wireless device and the peer wireless device;
   select a resource block in which to transmit the sequence; and/or
   select a subchannel on which to transmit the sequence.
      X44. The method of embodiment X43, wherein the control signaling indicates one or more rules according to which the wireless device is to generate the sequence.
      X45. The method of embodiment A44, wherein the one or more rules indicate the sequence is to be generated based on an identity of the peer wireless device.
      X46. The method of embodiment A45, wherein the sequence is a version of a base sequence, wherein according to the one or more rules the base sequence is based on the identity of the peer wireless device, wherein the version of the base sequence is a phase-rotated version of the base sequence or a cyclically-shifted version of the base sequence.
      X47. The method of embodiment X46, wherein a phase rotation of the base sequence, or a cyclic shift of the base sequence, is based on an identity of the wireless device.
      X48. The method of any of embodiments X43-X47, wherein the one or more rules indicate the sequence is to be generated based on a distance between the wireless device and the peer wireless device.
      X49. The method of embodiment X48, wherein the one or more rules indicate different ranges of distances are associated with different sequences.
      X50. The method of any of embodiments X48-X49, wherein the sequence is a version of a base sequence, wherein the base sequence is based on an identity of the peer wireless device and the distance between the wireless device and the peer wireless device, wherein the version of the base sequence is a phase-rotated version of the base sequence or a cyclically-shifted version of the base sequence, wherein the one or more rules indicate different ranges of distances are associated with different base sequences.
      X51. The method of any of embodiments X43-X50, wherein the control signaling indicates one or more rules according to which the wireless device is to select a resource block in which to transmit the sequence.
      X52. The method of embodiment X51, wherein the one or more rules indicate the resource block is to be selected based on an identity of the wireless device.
      X53. The method of any of embodiments X51-X52, wherein the one or more rules indicate the resource block is to be selected based on whether the acknowledgement feedback to be conveyed indicates positive acknowledgement of the data transmission or negative acknowledgement of the data transmission.
      X54. The method of embodiment X53, wherein the one or more rules indicate different resource blocks are to be used for conveying positive acknowledgement and negative acknowledgement.
      X55. The method of any of embodiments X43-X54, wherein the control signaling indicates one or more rules according to which the wireless device is to select a subchannel on which to transmit the sequence.
      X56. The method of embodiment X55, wherein the one or more rules indicate prioritization rules for prioritizing on which of multiple subchannels the sequence is to be transmitted.
      X57. The method of any of embodiments X43-X56, wherein the data transmission is a vehicle-to-everything, V2X, data transmission on a sidelink between the wireless device and the peer wireless device.
      X58. The method of any of embodiments X43-X57, wherein the sequence is transmitted on a physical sidelink feedback channel, PSFCH.
      X59. The method of any of embodiments X43-X58, further comprising receiving the sequence that conveys the acknowledgment feedback according to the one or more rules.

### GROUP B EMBODIMENTS

B1. A method performed by a radio network node, the method comprising:
transmitting control signaling indicating one or more rules according to which a wireless device is to:
   generate a sequence for conveying acknowledgement feedback for a data transmission received from a peer wireless device on a sidelink between the wireless device and the peer wireless device;
   select a resource block in which to transmit the sequence; and/or
   select a subchannel on which to transmit the sequence.
      B2. The method of embodiment B1, wherein the control signaling indicates one or more rules according to which the wireless device is to generate the sequence.
      B3. The method of embodiment B2, wherein the one or more rules indicate the sequence is to be generated based on an identity of the peer wireless device.
      B4. The method of embodiment B3, wherein the sequence is a version of a base sequence, wherein according to the one or more rules the base sequence is based on the identity of the peer wireless device, wherein the version of the base sequence is a phase-rotated version of the base sequence or a cyclically-shifted version of the base sequence.
      B5. The method of embodiment B4, wherein a phase rotation of the base sequence, or a cyclic shift of the base sequence, is based on an identity of the wireless device.
      B6. The method of any of embodiments B1-B5, wherein the one or more rules indicate the sequence is to be generated based on a distance between the wireless device and the peer wireless device.
      B7. The method of embodiment B6, wherein the one or more rules indicate different ranges of distances are associated with different sequences.
      B8. The method of any of embodiments B6-B7, wherein the sequence is a version of a base sequence, wherein the base sequence is based on an identity of the peer wireless device and the distance between the wireless device and the peer wireless device, wherein the version of the base sequence is a phase-rotated version of the base sequence or a cyclically-shifted version of the base sequence, wherein the one or more rules indicate different ranges of distances are associated with different base sequences.
      B9. The method of any of embodiments B1-B8, wherein the control signaling indicates one or more rules according to which the wireless device is to select a resource block in which to transmit the sequence.
      B10. The method of embodiment B9, wherein the one or more rules indicate the resource block is to be selected based on an identity of the wireless device.
      B11. The method of any of embodiments B9-610, wherein the one or more rules indicate the resource block is to be selected based on whether the acknowledgement feedback to be conveyed indicates positive acknowledgement of the data transmission or negative acknowledgement of the data transmission.
      B12. The method of embodiment B11, wherein the one or more rules indicate different resource blocks are to be used for conveying positive acknowledgement and negative acknowledgement.
      B13. The method of any of embodiments B1-B12, wherein the control signaling indicates one or more rules according to which the wireless device is to select a subchannel on which to transmit the sequence.
      B14. The method of embodiment B13, wherein the one or more rules indicate prioritization rules for prioritizing on which of multiple subchannels the sequence is to be transmitted.
      B15. The method of any of embodiments B1-B14, wherein the data transmission is a vehicle-to-everything, V2X, data transmission on a sidelink between the wireless device and the peer wireless device.
      B16. The method of any of embodiments B1-B15, wherein the sequence is transmitted on a physical sidelink feedback channel, PSFCH.
      BB. The method of any of the previous embodiments, further comprising:
obtaining user data; and
forwarding the user data to a host computer or a wireless device.

### GROUP C EMBODIMENTS

C1. A wireless device configured to perform any of the steps of any of the Group A or Group X embodiments.
C2. A wireless device comprising processing circuitry configured to perform any of the steps of any of the Group A or Group X embodiments.
C3. A wireless device comprising:
communication circuitry; and
processing circuitry configured to perform any of the steps of any of the Group A or Group X embodiments.
   C4. A wireless device comprising:
processing circuitry configured to perform any of the steps of any of the Group A or Group X embodiments; and
power supply circuitry configured to supply power to the wireless device.
   C5. A wireless device comprising:
processing circuitry and memory, the memory containing instructions executable by the processing circuitry whereby the wireless device is configured to perform any of the steps of any of the Group A or Group X embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A or Group X embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a wireless device, causes the wireless device to carry out the steps of any of the Group A or Group X embodiments.
   C8. A carrier containing the computer program of embodiment C7, wherein the carrier is one of an electronic signal, optical signal, radio signal, or computer readable storage medium.
   C9. A radio network node configured to perform any of the steps of any of the Group B embodiments.
   C10. A radio network node comprising processing circuitry configured to perform any of the steps of any of the Group B embodiments.
   C11. A radio network node comprising:
communication circuitry; and
processing circuitry configured to perform any of the steps of any of the Group B embodiments.
   C12. A radio network node comprising:
processing circuitry configured to perform any of the steps of any of the Group B embodiments;
power supply circuitry configured to supply power to the radio network node.
   C13. A radio network node comprising:
processing circuitry and memory, the memory containing instructions executable by the processing circuitry whereby the radio network node is configured to perform any of the steps of any of the Group B embodiments.
   C14. The radio network node of any of embodiments C9-C13, wherein the radio network node is a base station.
   C15. A computer program comprising instructions which, when executed by at least one processor of a radio network node, causes the radio network node to carry out the steps of any of the Group B embodiments.
   C16. The computer program of embodiment C14, wherein the radio network node is a base station.
   C17. A carrier containing the computer program of any of embodiments C15-C16, wherein the carrier is one of an electronic signal, optical signal, radio signal, or computer readable storage medium.

### GROUP D EMBODIMENTS

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.
   At least some of the following abbreviations may be used in this disclosure. If there is an inconsistency between abbreviations, preference should be given to how it is used above. If listed multiple times below, the first listing should be preferred over any subsequent listing(s).
ACK Acknowledgement
BSM Basic Safety Message
CAM Cooperative awareness message
D2D Device-to-device communication
DENM Decentralized Environmental Notification Message
HARQ Hybrid automatic repeat request
LTE Long-term evolution
NACK Negative acknowledgement
NR New radio
NW Network
PSCCH Physical sidelink control channel
PSFCH Physical sidelink feedback channel
PSSCH Physical sidelink shared channel
PUCCH Physical uplink control channel
RB Resource block
SAE Society of the Automotive Engineers
SCI Sidelink control information
SL Sidelink
UE User equipment
V21 Vehicle-to-infrastructure
V2P Vehicle-to-pedestrian
V2V Vehicle-to-vehicle
V2X Vehicle-to-anything communication
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDUCommon Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1.-72. (canceled)

73. A method performed by a wireless device, the method comprising:
receiving a data transmission from a peer wireless device on a sidelink between the wireless device and the peer wireless device; and
transmitting, to the peer wireless device, a sequence that is based on an identity of the peer wireless device, wherein transmission of the sequence conveys acknowledgement feedback for the data transmission.

74. The method of claim 73, further comprising generating or selecting the sequence based on the identity of the peer wireless device.

75. The method of claim 73, wherein the sequence is also based on an identity of the wireless device.

76. The method of claim 73, wherein the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

77. The method of claim 73, further comprising selecting a resource block in which to transmit the sequence, wherein selecting the resource block is based on an identity of the wireless device, and wherein transmitting the sequence comprises transmitting the sequence in the selected resource block.

78. The method of claim 73, further comprising selecting a resource block in which to transmit the sequence on a certain subchannel, wherein selecting the resource block comprises selecting the resource block among multiple resource blocks in the certain subchannel, and wherein transmitting the sequence comprises transmitting the sequence in the selected resource block.

79. The method of claim 73, wherein transmitting the sequence comprises transmitting the sequence on the same subchannel as the subchannel on which the data transmission is received.

80. The method of claim 73, wherein the data transmission is a vehicle-to-everything (V2X) data transmission on a sidelink between the wireless device and the peer wireless device.

81. The method of claim 73, wherein the sequence is transmitted on a physical sidelink feedback channel (PSFCH).

82. A method performed by a peer wireless device, the method comprising:
transmitting a data transmission from the peer wireless device to a wireless device on a sidelink between the wireless device and the peer wireless device; and
receiving, from the wireless device, a transmission of a sequence that is based on an identity of the peer wireless device, wherein the transmission of the sequence conveys acknowledgement feedback for the data transmission.

83. The method of claim 82, wherein the sequence is also based on an identity of the wireless device.

84. The method of claim 82, wherein the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

85. The method of claim 82, wherein the sequence is received on a resource block associated with an identity of the wireless device.

86. The method of claim 82, wherein receiving the sequence comprises receiving the sequence on the same subchannel as the subchannel on which the data transmission is transmitted.

87. The method of claim 82, wherein the data transmission is a vehicle-to-everything (V2X) data transmission on a sidelink between the wireless device and the peer wireless device.

88. The method of claim 82, wherein the sequence is received on a physical sidelink feedback channel (PSFCH).

89. A wireless device comprising:
communication circuitry; and
processing circuitry configured to:
receive a data transmission from a peer wireless device on a sidelink between the wireless device and the peer wireless device; and
transmit, to the peer wireless device, a sequence that is based on an identity of the peer wireless device, wherein transmission of the sequence conveys acknowledgement feedback for the data transmission.

90. The wireless device of claim 89, wherein the processing circuitry is further configured to generate or select the sequence based on the identity of the peer wireless device.

91. The wireless device of claim 89, wherein the sequence is also based on an identity of the wireless device.

92. The wireless device of claim 89, wherein the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

93. The wireless device of claim 89, wherein the processing circuitry is configured to:
select a resource block in which to transmit the sequence, based on an identity of the wireless device, wherein the sequence is transmitted in the selected resource block; or
select a resource block in which to transmit the sequence on a certain subchannel, wherein the resource block is selected among multiple resource blocks in the certain subchannel, and wherein the sequence is transmitted in the selected resource block.

94. The wireless device of claim 89, wherein the processing circuitry is configured to transmit the sequence on the same subchannel as the subchannel on which the data transmission is received.

95. A peer wireless device comprising:
communication circuitry; and
processing circuitry configured to:
transmit a data transmission from the peer wireless device to a wireless device on a sidelink between the wireless device and the peer wireless device; and
receive, from the wireless device, a transmission of a sequence that is based on an identity of the peer wireless device, wherein the transmission of the sequence conveys acknowledgement feedback for the data transmission.

96. The peer wireless device of claim 91, wherein the sequence is also based on an identity of the wireless device.

97. The peer wireless device of claim 91, wherein the sequence is a version of a base sequence, wherein the version of the base sequence is a phase-rotated version of the base sequence or a cyclically-shifted version of the base sequence, and wherein a phase rotation of the base sequence, or a cyclic shift of the base sequence, is based on an identity of the wireless device.

98. The peer wireless device of claim 91, wherein the processing circuitry is configured to receive the sequence on a resource block associated with an identity of the wireless device and/or on the same subchannel as the subchannel on which the data transmission is transmitted.
